(19) United States
(12) Patent Application Publication
(10) Pub. No.: US 2020/0211399 A1
(43) Pub. Date: Jul. 2, 2020

(54) Information Transmission Method, Traffic Control Unit, and On-Board Unit

(71) Applicant: Huawei Technologies Co., Ltd., Shenzhen (CN)

(72) Inventors: Yi Zhang, Beijing (CN); Hui Li, Shenzhen (CN)

(21) Appl. No.: 16/818,589

(22) Filed: Mar. 13, 2020

Related U.S. Application Data
(63) Continuation of application No. PCT/CN2018/105443, filed on Sep. 13, 2018.

(30) Foreign Application Priority Data
Sep. 14, 2017 (CN) 201710828735.7

(51) Int. Cl. G08G 1/16; G08G 1/0967; G01C 21/34

(52) U.S. Cl. CPC G08G 1/167; G01C 21/3492; G08G 1/164; G08G 1/096775

(57) ABSTRACT

A road information transmission method includes obtaining, by the traffic control unit (TCU), a planned route of a vehicle, performing, by the TCU, extension based on the planned route to generate a drivable area of the vehicle on the planned route, where the drivable area includes a safe driving area for the vehicle, and sending, by the TCU, road information to the on-board unit (OBU), where the road information includes indication information of the drivable area.

### CROSS-REFERENCE TO RELATED APPLICATIONS

This application is a continuation of International Patent Application No. PCT/CN2018/105443, filed on Sep. 13, 2018, which claims priority to Chinese Patent Application No. 201710828735.7, filed on Sep. 14, 2017, both of which are hereby incorporated by reference in their entireties.

### TECHNICAL FIELD

Embodiments of this application relate to the traffic information field, and in particular, to an information transmission method, a traffic control unit (TCU), and an on-board unit (OBU).

### BACKGROUND

With development of science and technology, transport systems such as self driving, an advanced driver assistant system (ADAS), and an intelligent transport system (ITS) gain more attention from people. In these transport systems, a high-precision map plays a very important role.

In a transport system, a high-precision map may be stored locally (in other words, at a vehicle end), and an OBU may control a vehicle based on the locally stored high-precision map. However, because the high-precision map has relatively high precision, an amount of data of the high-precision map is very large (for example, data per square kilometer reaches a gigabyte (GB) level). Consequently, it is difficult to update the high-precision map stored at the vehicle end. In addition, according to a related regulation, the high-precision map is confidential data, and should not be stored at the vehicle end.

In the transport system, to avoid a disadvantage of locally storing the high-precision map, the high-precision map may not be locally stored, but may be delivered using a server. For example, the server delivers the high-precision map to the OBU using a tiling method, and the OBU may control a vehicle based on the received tiled high-precision map. However, because the high-precision map has a huge amount of data, even if the high-precision map is delivered using the tiling manner, an amount of data delivered each time is also very huge. Consequently, it is difficult for the OBU to quickly receive and load a tile map. In addition, the high-precision map is confidential data. When data is sent using a tile, it is easy for a receive end to gather a plurality of tiles to form a map copy. Consequently, there is a map leakage risk.

Therefore, when a requirement of the OBU for controlling a vehicle is met, how to find a solution in which there is a small amount of transmitted data and there is no leakage of a high-precision map becomes a problem that urgently needs to be resolved.

### SUMMARY

Embodiments of this application provide an information transmission method, a TCU, and an OBU, to transmit a small amount of data with high security when a requirement of the OBU for controlling a vehicle is met.

According to a first aspect, a road information transmission method is provided. The method includes obtaining, by a TCU, a planned route of a vehicle, performing, by the TCU, extension based on the planned route to generate a drivable area of the vehicle on the planned route, where the drivable area includes a safe driving area for the vehicle, and sending, by the TCU, road information to an on-board OBU, where the road information includes indication information of the drivable area.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

Optionally, in an implementation, the method may further include obtaining, by the TCU, a current location and a destination location of the OBU. The obtaining, by a TCU, a planned route of a vehicle includes performing, by the TCU, route planning based on the current location and the destination location of the OBU, to obtain the planned route of the vehicle.

It should be understood that the current location of the OBU obtained by the TCU may be reported by the OBU to the TCU, and the destination location of the OBU may be reported by the OBU to the TCU or may be determined by the TCU. This embodiment of this application is not limited thereto.

Optionally, in an implementation, the TCU obtains the current location and the destination location that are reported by the OBU. In this case, reporting the current location and the destination location by the OBU may correspond to a case in which a user requests route planning.

Alternatively, in an implementation, the TCU determines the destination location, and receives the current location reported by the OBU. In this case, the OBU may report the current location, and the TCU plans the destination location. For example, in a self driving scenario, the TCU (for example, a center server) plans a destination of a vehicle, or the TCU (for example, a causing apparatus) determines a destination by modifying partial route planning of the OBU to avoid congestion.

The foregoing describes a solution in which the TCU determines the planned route of the vehicle. Optionally, in this embodiment of this application, the TCU may not need to determine the planned route, but directly uses the planned route. Correspondingly, in an implementation, the obtaining, by a TCU, a planned route of a vehicle includes obtaining, by the TCU, the planned route of the vehicle reported by the OBU.

Specifically, the OBU reports the planned route, and the TCU directly uses the planned route for area extension, to obtain the drivable area. Route planning reported by the OBU may be determined by the OBU, or may be obtained from a third-party device. For example, the OBU may perform route planning based on a low-precision map, to obtain the planned route, and then the OBU reports the planned route to the TCU. It should be understood that the planned route reported by the OBU may be a planned route from the current location to the destination, or may be a temporary planned route of a short distance, such as going straight/turning left. This embodiment of this application is not limited thereto.

Optionally, the planned route reported by the OBU may be alternatively obtained from the third-party device. Specifically, the OBU receives the planned route sent by the third-party device, and then the OBU reports the planned route to the TCU. For example, the third-party device may be a navigation apparatus, a map apparatus (for example, an apparatus on which Baidu Map or Google Maps is run), a map device, or another device having a route planning function. This embodiment of this application is not limited thereto.

The foregoing describes the case in which the TCU determines the planned route or receives the planned route reported by the OBU. Alternatively, the TCU may directly receive the planned route sent by the third-party device. The third-party device may actively send the planned route to the TCU. Alternatively, the third-party device sends the planned route to the TCU after the TCU sends a request to the third-party device. This embodiment of this application is not limited thereto.

It should be understood that the TCU may directly use the planned route after receiving the planned route sent by the OBU or the third-party device, or may convert the planned route into a planned route in a high-precision map, and then perform route extension. This is not limited in this embodiment of this application.

Optionally, in an implementation, the drivable area includes a safe driving area for the vehicle on the entire planned route, or the drivable area includes a safe driving area for the vehicle on a segment of a road on the planned route.

Optionally, in an implementation, the drivable area includes at least one of a first choice drivable area, a compliance drivable area, and an emergency avoidance drivable area, the emergency avoidance drivable area includes the compliance drivable area, and the compliance drivable area includes the first choice drivable area, the first choice drivable area includes an area formed by all lanes on which the vehicle moves in compliance with a traffic regulation, the compliance drivable area includes all areas in which the vehicle moves in compliance with a traffic regulation, and the emergency avoidance drivable area includes an area in which no collision occurs when the vehicle moves.

Optionally, in an implementation, the performing, by the TCU, extension based on the planned route to generate a drivable area of the vehicle on the planned route includes segmenting, by the TCU, the planned route into a plurality of segments of a road, extending each of the plurality of segments of the road on condition of a lane on which driving is performed in compliance with a traffic regulation, to obtain a first choice drivable area corresponding to each segment of the road, extending each of the plurality of segments of the road on condition that driving is performed in compliance with a traffic regulation, to obtain a compliance drivable area corresponding to each segment of the road, and extending each of the plurality of segments of the road on condition that no collision occurs, to obtain an emergency avoidance drivable area corresponding to each segment of the road.

It should be understood that a route may be segmented in a plurality of manners in this embodiment of this application. For example, the planned route may be segmented using an intersection, and on a super long straight route, the straight route may be segmented again based on a length. In this embodiment of this application, after the route is segmented, each of the plurality of segments of the road is extended on condition of the lane (which may also be referred to as a non-violation lane) on which driving is performed in compliance with a traffic regulation, to obtain the first choice drivable area corresponding to each segment of the road, each of the plurality of segments of the road is extended on condition that driving is performed in compliance with a traffic regulation (which may also be referred to as a non-violation area), to obtain the compliance drivable area corresponding to each segment of the road, and each of the plurality of segments of the road is extended on condition that no collision occurs (which may also be referred to as a non-collision area), to obtain the emergency avoidance drivable area corresponding to each segment of the road.

It should be specially noted that, if a current road segment falls within an intersection range, the first choice drivable area may be determined using a virtual lane line algorithm in this embodiment of this application. For example, in this embodiment of this application, a smooth curve obtained through spline interpolation may be used as the “first choice drivable area”. It should be understood that a virtual lane line may be obtained using a plurality of fitting algorithms in this embodiment of this application, such as cubic spline interpolation, quadratic spline interpolation, or the least square method. This embodiment of this application is not limited thereto.

When an entire drivable area is to be sent, the TCU may reckon a drivable area of a previous (next) segment of the road based on a vehicle driving direction, and another drivable area may be obtained through successive recursion, until the entire drivable area is obtained.

Optionally, in a scenario in which a drivable area is delivered by segments, only a drivable area within a segment range may be sent. For example, a drivable area that is 1000 meters in front of the current location and 200 meters behind the current location is sent.

It should be understood that a name of the drivable area is not limited in this embodiment of this application. The first choice drivable area may also be referred to as a best drivable area, the compliance drivable area may also be referred to as a better drivable area, and the emergency avoidance drivable area may also be referred to as a poorest drivable area. Optionally, the foregoing three drivable areas may also be respectively referred to as a first area, a second area, and a third area. This embodiment of this application is not limited thereto.

It should be understood that, in actual application, the drivable area may include one, two, or all of the foregoing three areas. This embodiment of this application is not limited thereto. Only the example in which the drivable area is divided into the three areas is used above for description. The three areas provided above through division is only an example. A person skilled in the art may obtain a corresponding rule variant according to a division rule in the foregoing embodiment. Correspondingly, when the division rule is changed, a granularity of dividing the drivable area may also be accordingly changed. For example, the drivable area may be divided into two areas or four areas. Such a change also falls within the protection scope of this embodiment of this application.

Optionally, in an implementation, the indication information includes at least one of the following two a left boundary line and a right boundary line that are used to indicate the drivable area, where the left boundary line indicates a left boundary on which the vehicle moves in the drivable area, and the right boundary line indicates a right boundary on which the vehicle moves in the drivable area, and lane information used to indicate the drivable area, where the lane information is used to indicate all lanes in the drivable area.

It should be understood that, in this embodiment of this application, the three areas may all be indicated using either of boundary lines or road information. The following provides detailed descriptions using an example in which the emergency avoidance drivable area and the compliance drivable area are indicated using boundary lines and the first choice drivable area is indicated using road information.

Optionally, in an implementation, the indication information includes a first left boundary line and a first right boundary line that are used to indicate the emergency avoidance drivable area, where the first left boundary line indicates a left boundary on which a vehicle corresponding to the emergency avoidance drivable area moves, and the first right boundary line indicates a right boundary on which the vehicle corresponding to the emergency avoidance drivable area moves, a second left boundary line and a second right boundary line that are used to indicate the compliance drivable area, where the second left boundary line indicates a left boundary on which a vehicle corresponding to the compliance drivable area moves, the second right boundary line indicates a right boundary on which the vehicle corresponding to the compliance drivable area moves, and the second left boundary and the second right boundary are surrounded by the first left boundary and the first right boundary, and first lane information used to indicate the first choice drivable area, where the first lane information is used to indicate all the lanes when the vehicle complies with a traffic regulation.

The “first choice drivable area” described in this specification is usually a “non-violation lane”. During implementation, the area may include attributes such as a lane line, a lane midline, a lane line type, and a direction. The OBU may perform vehicle to everything (V2X) warning, trajectory planning, or the like based on the information. It should be understood that, in this embodiment of this application, the lane information may have a plurality of forms. The following respectively provides detailed descriptions of three cases using the first choice drivable area as an example.

First Case

Optionally, in an implementation, the first lane information includes lane lines of all the lanes on which the vehicle moves in compliance with a traffic regulation, and the lane lines include a virtual lane line at an intersection and actual lane lines on the lanes.

Optionally, in an implementation, the first lane information further includes directions of all the lanes on which the vehicle moves in compliance with a traffic regulation, and/or types of the lane lines.

Second Case

Optionally, in an implementation, the first lane information includes lane midlines of all the lanes on which the vehicle moves in compliance with a traffic regulation.

Optionally, in an implementation, the first lane information further includes at least one of the following information a lane width, a lane direction, and a lane change attribute of a lane corresponding to a lane midline.

Third Case

Optionally, in an implementation, the first lane information includes a trajectory planning line on which the vehicle moves in compliance with a traffic regulation and a slicing line of the trajectory planning line, where the slicing line intersects a lane line and/or a lane midline that are/is passed when the vehicle moves in compliance with a traffic regulation.

Optionally, in an implementation, the first lane information further includes at least one of the following information a lane direction of a lane intersecting the slicing line, a type of the lane line, a width of the lane, and a lane change attribute.

It should be understood that, in this embodiment of this application, to enable the OBU to replace a map with the drivable area, the TCU may further send additional information corresponding to the drivable area to the OBU. Correspondingly, in an implementation, the road information further includes at least one of the following information traffic sign information, speed limiting information, traffic flow information, road grade information, a road material and a friction coefficient, traffic event information, and obstacle bitmap information.

It should be understood that the traffic event information may include information about road maintenance, a traffic accident, road construction, and the like, and the obstacle bitmap information may include bitmap information of a vehicle or an obstacle located in the drivable area.

Correspondingly, after obtaining the road information, the OBU may correspondingly control the vehicle. For example, in a self driving system, the OBU plans a trajectory of the vehicle in the drivable area, and may complete an action such as obstacle avoidance or lane change based on the drivable area.

In an assisted driving (ADAS/ITS/V2X) system, the OBU determines a spatio-temporal relationship between a vehicle and a peripheral vehicle in the drivable area, to implement a function such as collision prediction, lane change assistance, intersection guide, or violation identification.

It should be noted that the foregoing describes the method in a transport system scenario. Optionally, this embodiment of this application may be applied to another system, such as a robot system, an unmanned aerial vehicle system, or an automated warehouse system. In a robot system, an unmanned aerial vehicle system, an automated warehouse system, or the like, the TCU in this embodiment of this application may be replaced with a control center, the OBU may be replaced with a local apparatus, and the local apparatus may greatly simplify a route planning algorithm in the apparatus based on the drivable area. For a method applied to another system, refer to the foregoing descriptions of the transport system. Details are not described herein again.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains the road information such that calculation complexity of the OBU can be reduced, and vehicle control performance can be improved.

According to a second aspect, a road information transmission method is provided. The method includes receiving, by an OBU, road information sent by a TCU, where the road information includes indication information of a drivable area, the drivable area includes a safe driving area of a vehicle, and the safe driving area is obtained by extending a planned route between a current location and a destination location of the OBU, and controlling, by the OBU, the vehicle based on the road information.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

It should be understood that the road information transmission method corresponding to an OBU side is described in the second aspect, the road information transmission method on a TCU side is described in the first aspect, and the method in the second aspect corresponds to the method in the first aspect. For a process and effects of the method in the second aspect, refer to the descriptions in the first aspect. To avoid repetition, detailed descriptions are properly omitted herein.

Optionally, in an implementation, the drivable area includes at least one of a first choice drivable area, a compliance drivable area, and an emergency avoidance drivable area, the emergency avoidance drivable area includes the compliance drivable area, and the compliance drivable area includes the first choice drivable area, the first choice drivable area includes an area formed by all lanes on which the vehicle moves in compliance with a traffic regulation, the compliance drivable area includes all areas in which the vehicle moves in compliance with a traffic regulation, and the emergency avoidance drivable area includes an area in which no collision occurs when the vehicle moves.

Optionally, in an implementation, the indication information includes at least one of the following two a left boundary line and a right boundary line that are used to indicate the drivable area, where the left boundary line indicates a left boundary on which the vehicle moves in the drivable area, and the right boundary line indicates a right boundary on which the vehicle moves in the drivable area, and lane information used to indicate the drivable area, where the lane information is used to indicate all lanes in the drivable area.

Optionally, in an implementation, the indication information includes a first left boundary line and a first right boundary line that are used to indicate the emergency avoidance drivable area, where the first left boundary line indicates a left boundary on which a vehicle corresponding to the emergency avoidance drivable area moves, and the first right boundary line indicates a right boundary on which the vehicle corresponding to the emergency avoidance drivable area moves, a second left boundary line and a second right boundary line that are used to indicate the compliance drivable area, where the second left boundary line indicates a left boundary on which a vehicle corresponding to the compliance drivable area moves, the second right boundary line indicates a right boundary on which the vehicle corresponding to the compliance drivable area moves, and the second left boundary and the second right boundary are surrounded by the first left boundary and the first right boundary, and first lane information used to indicate the first choice drivable area, where the first lane information is used to indicate all the lanes when the vehicle complies with a traffic regulation.

Optionally, in an implementation, the first lane information includes lane lines of all the lanes on which the vehicle moves in compliance with a traffic regulation, and the lane lines include a virtual lane line at an intersection and actual lane lines on the lanes.

Optionally, in an implementation, the first lane information further includes directions of all the lanes on which the vehicle moves in compliance with a traffic regulation, and/or types of the lane lines.

Optionally, in an implementation, the first lane information includes lane midlines of all the lanes on which the vehicle moves in compliance with a traffic regulation.

Optionally, in an implementation, the first lane information further includes at least one of the following information a lane width, a lane direction, and a lane change attribute of a lane corresponding to a lane midline.

Optionally, in an implementation, the first lane information includes a trajectory planning line on which the vehicle moves in compliance with a traffic regulation and a slicing line of the trajectory planning line, where the slicing line intersects a lane line and/or a lane midline that are/is passed when the vehicle moves in compliance with a traffic regulation.

Optionally, in an implementation, the first lane information further includes at least one of the following information a lane direction of a lane intersecting the slicing line, a type of the lane line, a width of the lane, and a lane change attribute.

Optionally, in an implementation, the road information further includes at least one of the following information traffic sign information, speed limiting information, traffic flow information, road grade information, a road material and a friction coefficient, traffic event information, and obstacle bitmap information.

Optionally, in an implementation, the drivable area includes a safe driving area for the vehicle on the entire planned route, or the drivable area includes a safe driving area for the vehicle on a segment of a road on the planned route.

Optionally, in an implementation, the method further includes sending, by the OBU, the current location and the destination location to the TCU, or sending, by the OBU, the current location to the TCU, or determining, by the OBU, the planned route, or receiving, by the OBU, the planned route sent by a third-party device, and sending, by the OBU, the planned route to the TCU.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains the road information such that calculation complexity of the OBU can be reduced, and vehicle control performance can be improved.

According to a third aspect, a TCU is provided. The TCU is configured to perform the method in any one of the first aspect or the possible implementations of the first aspect. Specifically, the TCU includes a corresponding means configured to perform a step or a function described in an aspect of the method. The step or the function may be implemented by software, by hardware, or by a combination of hardware and software.

In a possible design, the TCU includes one or more processing units and a transceiver unit. The one or more processing units are configured to support the TCU in performing a corresponding function in the foregoing method, for example, generating a drivable area. The transceiver unit is configured to support the TCU in communicating with an OBU, to implement a receiving/sending function, for example, sending the drivable area.

Optionally, the TCU may further include one or more memories, the memory is configured to be coupled to the processor, and stores a program instruction and data that are required by the TCU, for example, the memory may store a map data source. The one or more memories may be integrated with the processor, or may be separated from the processor. This is not limited in this embodiment of this application.

The transceiver unit may be a transceiver or a transceiver circuit.

The TCU may further be a communications chip. The transceiver unit may be an input/output circuit or an interface of the communications chip.

In another possible design, the TCU includes a transceiver, a processor, and a memory. The processor is configured to control the transceiver to receive and send a signal. The memory is configured to store a computer program. The processor is configured to invoke the computer program from the memory and run the computer program such that the TCU performs the method in any one of the first aspect or the possible implementations of the first aspect.

According to a fourth aspect, an OBU is provided. The OBU is configured to perform the method in any one of the second aspect or the possible implementations of the second aspect. Specifically, the OBU includes a corresponding means configured to perform a step or a function described in an aspect of the method. The step or the function may be implemented by software, by hardware, or by a combination of hardware and software.

In a possible design, the OBU includes one or more processing units and a transceiver unit. The transceiver unit is configured to support the OBU in communicating with a TCU device, to implement a receiving/sending function, for example, receiving road information or sending a current location. The one or more processors are configured to support the OBU in performing a corresponding function in the foregoing method.

Optionally, the OBU may further include one or more memories. The memory is configured to be coupled to the processor, and stores a program instruction and data that are required by the OBU. The one or more memories may be integrated with the processor, or may be separated from the processor. This is not limited in this embodiment of this application.

The transceiver unit may be a transceiver or a transceiver circuit.

The OBU may further be a communications chip. The transceiver unit may be an input/output circuit or an interface of the communications chip.

In another possible design, the OBU includes a transceiver, a processor, and a memory. The processor is configured to control the transceiver to receive and send a signal. The memory is configured to store a computer program. The processor is configured to invoke the computer program from the memory and run the computer program such that the OBU performs the method in any one of the second aspect or the possible implementations of the second aspect.

According to a fifth aspect, a transport system is provided, and the system includes the foregoing TCU and the foregoing OBU.

According to a sixth aspect, a computer program product is provided. The computer program product includes a computer program (which may also be referred to as code or an instruction), and when the computer program is run, a computer is enabled to perform the method in any one of the first aspect or the possible implementations of the first aspect, or in any one of the second aspect or the possible implementations of the second aspect.

According to a seventh aspect, a computer readable medium is provided. The computer readable medium stores a computer program (which may also be referred to as code or an instruction), and when the computer program is run on a computer, the computer is enabled to perform the method in any one of the first aspect or the possible implementations of the first aspect, or in any one of the second aspect or the possible implementations of the second aspect.

### BRIEF DESCRIPTION OF DRAWINGS

FIG. 1 is a schematic diagram of a transport system scenario to which embodiments of this application are applicable.

FIG. 2 is a schematic flowchart of a road information transmission method according to an embodiment of the embodiments of this application.

FIG. 3 is a schematic diagram of a drivable area according to an embodiment of the embodiments of this application.

FIG. 4 is a schematic diagram of a first choice drivable area according to an embodiment of the embodiments of this application.

FIG. 5 is a schematic diagram of a compliance drivable area according to an embodiment of the embodiments of this application.

FIG. 6 is a schematic diagram of an emergency avoidance drivable area according to an embodiment of the embodiments of this application.

FIG. 7 is a schematic flowchart of a planned route extension method according to an embodiment of the embodiments of this application.

FIG. 8 is a schematic diagram of planned route segmentation according to an embodiment of the embodiments of this application.

FIG. 9 is a schematic block diagram of route extension according to an embodiment of the embodiments of this application.

FIG. 10 is a schematic block diagram of determining a first choice drivable area at an intersection according to an embodiment of the embodiments of this application.

FIG. 11 is a schematic block diagram of determining a compliance drivable area and an emergency avoidance drivable area at intersections according to an embodiment of the embodiments of this application.

FIG. 12 is a schematic display diagram of an emergency avoidance drivable area according to an embodiment of the embodiments of this application.

FIG. 13 is a schematic display diagram of a first choice drivable area according to an embodiment of the embodiments of this application.

FIG. 14 is a schematic display diagram of a first choice drivable area according to another embodiment of the embodiments of this application.

FIG. 15 is a schematic display diagram of a first choice drivable area according to another embodiment of the embodiments of this application.

FIG. 16 is a schematic block diagram of a TCU according to an embodiment of the embodiments of this application.

FIG. 17 is a schematic block diagram of an OBU according to an embodiment of the embodiments of this application.

FIG. 18 is a schematic block diagram of a TCU according to another embodiment of the embodiments of this application.

FIG. 19 is a schematic block diagram of a TCU according to another embodiment of the embodiments of this application.

### DESCRIPTION OF EMBODIMENTS

The following describes technical solutions in embodiments of this application with reference to accompanying drawings.

It should be understood that the embodiments of this application may be applied to a plurality of systems, for example, a transport system such as a self driving system, an ADAS, or an ITS. Optionally, the embodiments of this application may further be applied to a robot system, an unmanned aerial vehicle system, or an automated warehouse system.

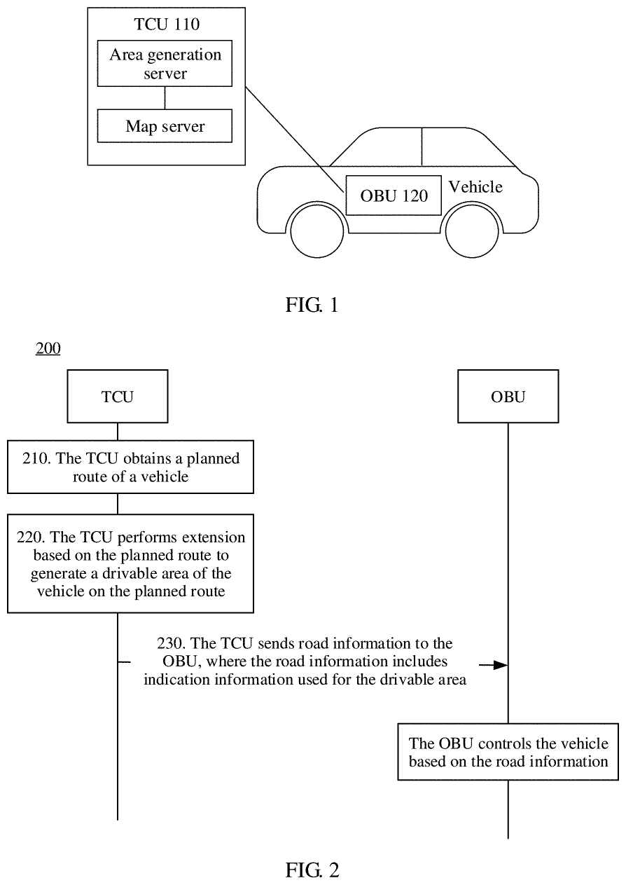

FIG. 1 is a schematic diagram of a transport system scenario to which embodiments of this application are applicable. A transport system shown in FIG. 1 includes a TCU 110 and an OBU 120.

It should be understood that the TCU in this embodiment of this application is a server delivering a drivable area to the OBU, and the TCU may be a collective name of a network side. In this embodiment of this application, the TCU has functions of generating a planned route based on a current location and a destination location of the OBU and sending the drivable area. The TCU may also be referred to as a traffic control center, a traffic control server, a center server, a navigation server, a control center, or the like. This embodiment of this application is not limited thereto.

In this embodiment of this application, the TCU may include a map server and an area generation server. The map server is a server capable of providing a map data source, and the map data source may be a high-precision map or a high-precision vehicle driving line. It should be understood that the high-precision vehicle driving line may be a historical vehicle driving trajectory line. The area generation server can read the map data source based on the current location and the destination location of the OBU, and generate and deliver the drivable area.

It should be understood that, in FIG. 1, the TCU is divided into two servers based on functions, in an embodiment, the map server and the map generation server. Actually, the two servers may be two independent servers, or may be an integrated server. The two independent servers are used as an example. The map server may be a third-party server, such as a GOOGLE MAPS server, a BAIDU Map server, or an AMAP server. The area generation server can obtain the map data source from the third-party server.

In this embodiment of this application, the OBU has functions of receiving the drivable area sent by the TCU and controlling a vehicle. In other words, the OBU is an apparatus that can receive and use the drivable area. In this embodiment of this application, the OBU may also be referred to as a vehicle-mounted apparatus, a vehicle control unit, or a vehicle control apparatus, and the OBU may be located in the vehicle or built in the vehicle, and is a component of the vehicle. Optionally, the OBU may also be a third-party apparatus. This embodiment of this application is not limited thereto. For example, the OBU may be a vehicle-mounted map terminal, such as a navigation device, a telematics processor (T-BOX), or an on-board diagnostics (OBD) system. Optionally, the OBU may further be a vehicle-mounted device implementing an ADAS service or an ITS service, for example, a vehicle-mounted device implementing a self driving service. The OBU may further be a pedestrian map terminal, such as a mobile phone or another terminal supporting a global positioning system (GPS). The OBU may further be another terminal, for example, a terminal in the surveying and mapping field. This embodiment of this application is not limited thereto.

It should be understood that, in this embodiment of this application, the drivable area is a safe driving area for the vehicle. For a definition of the drivable area, refer to the following description of 230 in FIG. 2. Details are not described herein.

In an existing solution, in a manner of delivering a high-precision map by a server, the OBU is enabled to control the vehicle based on a received high-precision map. However, the high-precision map has a relatively large amount of data. Therefore, in the manner of delivering a high-precision map by a server, an amount of transmitted data is large, and there is a high-precision map leakage risk.

In another solution, a server delivers only route planning. Even though an amount of data is small in this manner, delivering only route planning leads to excessively less information, a function of an entire map is not implemented, and a vehicle can move only based on a trajectory and cannot implement an operation such as road selection, lane keeping, lane change, or obstacle avoidance. Therefore, the technology is applied only to a low-risk low-speed apparatus in a fixed place, or only plays a navigation role by presenting a planned curve to a driver. The technology cannot be applied to a transport system, such as self driving, an ADAS, or an ITS.

In the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

A road information transmission method is described in the following in detail in an embodiment of this application with reference to a specific example in FIG. 2, and is applied to the transport system shown in FIG. 1. A method 200 shown in FIG. 2 includes the following steps.

210. A TCU obtains a planned route of a vehicle.

It should be understood that, in this embodiment of this application, the TCU may determine the planned route, or may obtain the planned route reported by an OBU. This embodiment of this application is not limited thereto.

Optionally, when the TCU determines the planned route, the method may further include obtaining, by the TCU, a current location and a destination location of the OBU, where that the TCU obtains the planned route of the vehicle includes performing, by the TCU, route planning based on the current location and the destination location, to obtain the planned route of the vehicle.

It should be understood that the current location of the OBU obtained by the TCU may be reported by the OBU to the TCU, and the destination location of the OBU may be reported by the OBU to the TCU or may be determined by the TCU. This embodiment of this application is not limited thereto.

The OBU may periodically report the current location, or may report the current location only once. Periodically reporting the current location by the OBU may correspond to a case in which the TCU sends a drivable area corresponding to a segment of a road. Reporting the current location once may correspond to a case in which the TCU sends a drivable area of an entire planned route. For details, refer to the following descriptions. Details are not described herein.

It should be understood that, in this embodiment of this application, the destination location may be an absolute destination, for example, a location existing on a map such as a hotel, a cinema, a coffee shop, or a user address. Optionally, the destination location may be alternatively a relative location, for example, an address corresponding to an intention that a vehicle goes straight or makes a turn within a specific range.

Optionally, in an embodiment, the TCU obtains the current location and the destination location that are reported by the OBU. In this case, reporting the current location and the destination location by the OBU may correspond to a case in which a user requests route planning.

Alternatively, in an embodiment, the TCU determines the destination location, and receives the current location reported by the OBU. In this case, the OBU may report the current location, and the TCU plans the destination location. For example, in a self driving scenario, the TCU (for example, a center server) plans a destination of a vehicle, or the TCU (for example, a causing apparatus) determines a destination by modifying partial route planning of the OBU to avoid congestion.

It should be understood that sequence points or a curve connecting a beginning location (the current location) and an ending location (the destination location) is referred to as a route, and a policy for constituting a route is referred to as route planning. Route planning precision in this embodiment of this application may be lane-level route planning based on a map data source (such as a high-precision map or a high-precision vehicle driving line).

It should be understood that the planned route in this embodiment of this application may also be referred to as a route planning line. This embodiment of this application is not limited thereto.

Specifically, the TCU may search the map data source based on the current location and the destination location for route planning, to obtain the planned route. For example, the TCU may perform route planning using a weighted shortest path search algorithm, and a weight may be a traffic congestion situation. The TCU may perform route planning using one of the following shortest path search algorithms an A* algorithm, a Dijkstra algorithm, and a Floyd algorithm. It should be understood that, in this embodiment of this application, the TCU may further perform route planning using another existing path planning algorithm. This embodiment of this application is not limited thereto.

It should be specially noted that, for a planning request (for example, going straight ahead, turning left, or turning right) for a relative destination, the TCU may output route planning with a limited length (for example, 500-meter route planning). In this way, the TCU only needs to look for a lane in a vehicle marching direction on a map, and select a straight lane, a left-turning lane, or a right-turning lane based on a request at an intersection, until the vehicle accumulatively moves 500 meters.

The foregoing describes a solution in which the TCU determines the planned route of the vehicle. Optionally, in this embodiment of this application, the TCU may not need to determine the planned route, but directly uses the planned route. Correspondingly, in an implementation, that the TCU obtains the planned route of the vehicle includes obtaining, by the TCU, the planned route of the vehicle reported by the OBU.

Specifically, the OBU reports the planned route, and the TCU directly uses the planned route for area extension, to obtain the drivable area. Route planning reported by the OBU may be determined by the OBU, or may be obtained from a third-party device. For example, the OBU may perform route planning based on a low-precision map, to obtain the planned route, and then the OBU reports the planned route to the TCU. It should be understood that the planned route reported by the OBU may be a planned route from the current location to the destination, or may be a temporary planned route of a short distance, such as going straight/turning left. This embodiment of this application is not limited thereto.

Optionally, the planned route reported by the OBU may be alternatively obtained from the third-party device. Specifically, the OBU receives the planned route sent by the third-party device, and then the OBU reports the planned route to the TCU. For example, the third-party device may be a navigation apparatus, a map apparatus (for example, an apparatus on which BAIDU Map or GOOGLE MAPS is run), a map device, or another device having a route planning function. This embodiment of this application is not limited thereto.

The foregoing describes the case in which the TCU determines the planned route or receives the planned route reported by the OBU. Alternatively, the TCU may directly receive the planned route sent by the third-party device. The third-party device may actively send the planned route to the TCU. Alternatively, the third-party device sends the planned route to the TCU after the TCU sends a request to the third-party device. This embodiment of this application is not limited thereto.

It should be understood that the TCU may directly use the planned route after receiving the planned route sent by the OBU or the third-party device, or may convert the planned route into a planned route in a high-precision map, and then perform route extension. This is not limited in this embodiment of this application.

220. The TCU performs extension based on the planned route to generate a drivable area of the vehicle on the planned route, where the drivable area includes a safe driving area for the vehicle.

To enable a route extension solution in this embodiment of this application to be easily understood, the following first describes the drivable area implemented in this embodiment of this application, and then describes how to perform extension based on the planned route to obtain the drivable area.

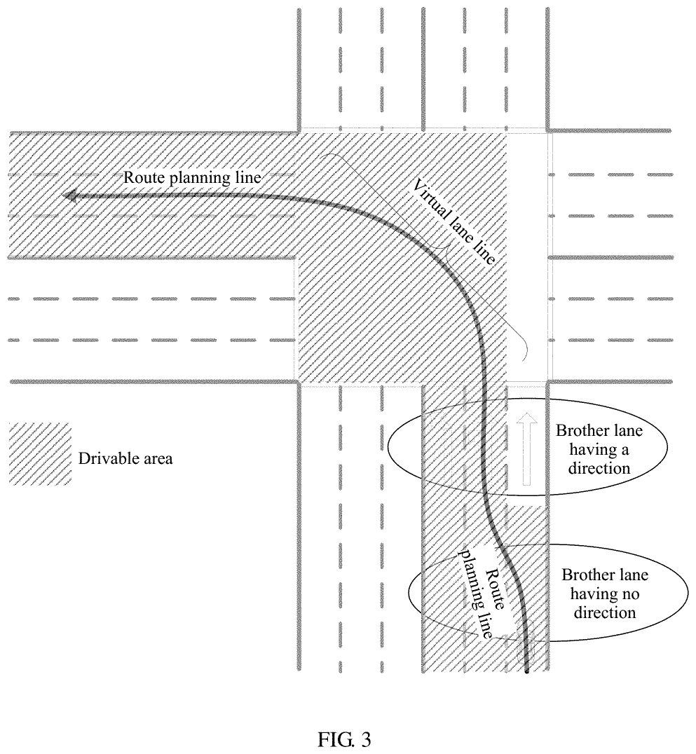

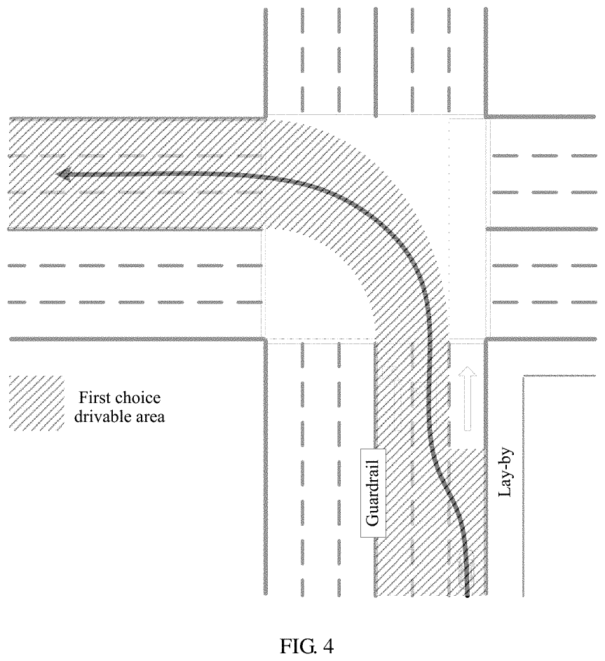

The drivable area in this embodiment of this application is first described. As shown in FIG. 3, a shadow part in FIG. 3 is a drivable area in this embodiment of this application. The area is obtained by extending a route planning line. The drivable area may generally include a brother lane in a same direction, an intersection area, and all lanes on which safe driving can be performed and that are far away from an intersection.

It should be noted that only a lane close to the intersection has a direction attribute, for example, a brother lane that has a direction and that is shown in FIG. 3. The direction attribute may include going straight, turning left, turning right, making a U-turn, going straight after turning left, going straight after turning right, or the like. A lane far away from the intersection has no direction attribute, for example, a brother lane that has no direction and that is in FIG. 3.

It should be understood that the entire intersection is the drivable area according to a traffic regulation. However, for comfortableness of a passenger, in this embodiment of this application, the TCU may obtain an optimal lane line through calculation at the intersection, and perform extension to obtain the drivable area at the intersection. As shown in FIG. 3, the lane line is referred to as a virtual lane line.

Optionally, in another embodiment, a similar map may include a plurality of layers. In this embodiment of this application, the drivable area is also allowed to have a plurality of layers.

Specifically, the drivable area includes at least one of a first choice drivable area, a compliance drivable area, and an emergency avoidance drivable area, and the emergency avoidance drivable area includes the compliance drivable area, and the compliance drivable area includes the first choice drivable area.

Specifically, the first choice drivable area includes an area formed by all lanes on which the vehicle moves in compliance with a traffic regulation, the compliance drivable area includes all areas in which the vehicle moves in compliance with a traffic regulation, and the emergency avoidance drivable area includes an area in which no collision occurs when the vehicle moves.

The following describes in detail the three drivable areas in this embodiment of this application with reference to FIG. 4 to FIG. 6.

As shown in FIG. 4, the first choice drivable area may include an area (excluding a lane having an unmatched direction) within a lane range or a coverage area of an optimal virtual lane line at an intersection.

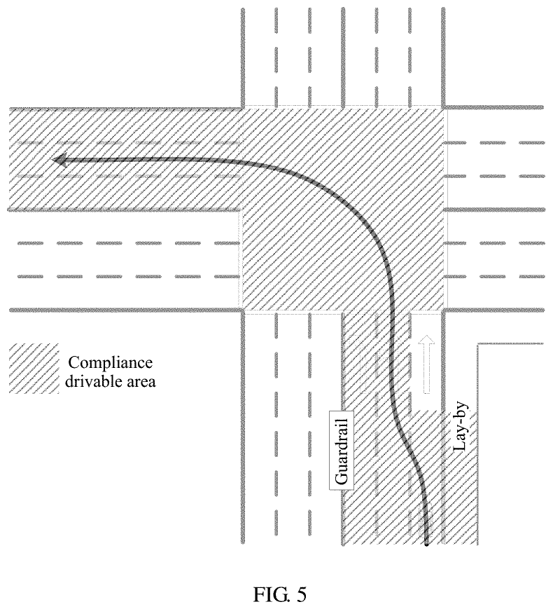

As shown in FIG. 5, the compliance drivable area includes an area in which no traffic regulation is violated, and additionally includes an entire intersection area, a lay-by area, and the like in comparison with the first choice drivable area.

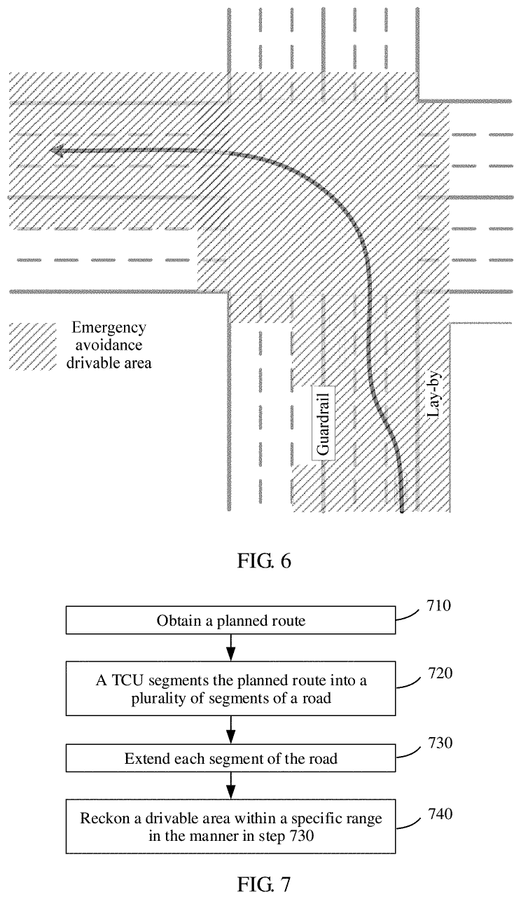

As shown in FIG. 6, the emergency avoidance drivable area includes all areas in which no collision occurs, and additionally includes a lane having an unmatched direction, some lanes on which retrograding driving is performed, and the like in comparison with the compliance drivable area. It should be understood that a vehicle moving in the area may violate a regulation.

It should be understood that the foregoing describes three drivable areas the first choice drivable area, the compliance drivable area, and the emergency avoidance drivable area. A name of the drivable area is not limited in this embodiment of this application. The first choice drivable area may also be referred to as a best drivable area, the compliance drivable area may also be referred to as a better drivable area, and the emergency avoidance drivable area may also be referred to as a poorest drivable area. Optionally, the foregoing three drivable areas may also be respectively referred to as a first area, a second area, and a third area. This embodiment of this application is not limited thereto.

It should be understood that, in actual application, the drivable area may include one, two, or all of the foregoing three areas. This embodiment of this application is not limited thereto. Only the example in which the drivable area is divided into the three areas is used above for description. The three areas provided above through division is only an example. A person skilled in the art may obtain a corresponding rule variant according to a division rule in the foregoing embodiment. Correspondingly, when the division rule is changed, a granularity of dividing the drivable area may also be accordingly changed. For example, the drivable area may be divided into two areas or four areas. Such a change also falls within the protection scope of this embodiment of this application.

When the drivable area in this embodiment of this application is limited, the following describes a method for performing extension based on the planned route to obtain the drivable area in this embodiment of this application with reference to FIG. 7.

Specifically, the method shown in FIG. 7 includes the following steps.

710. Obtain a planned route.

Specifically, a TCU performs route planning based on a map data source and based on a current location and a destination location of an OBU, to obtain the planned route.

720. The TCU segments the planned route into a plurality of segments of a road.

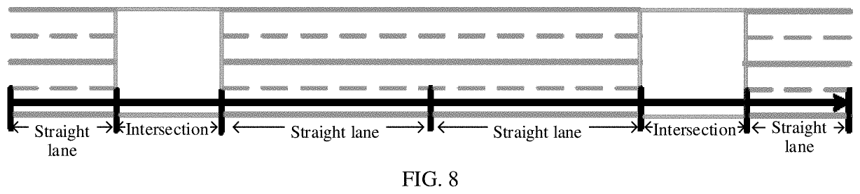

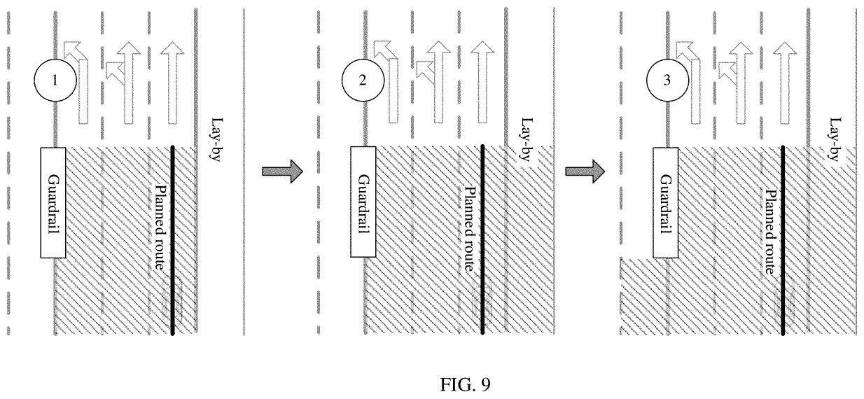

A route may be segmented in a plurality of manners in this embodiment of this application. For example, the planned route may be segmented using an intersection, and on a super long straight route, the straight route may be segmented again based on a length. FIG. 8 shows a segmentation method. On a planned route shown in FIG. 8, the planned route is segmented using two intersections, and a part between the two intersections is segmented again because the part is super long. Therefore, the planned route shown in FIG. 8 is segmented into six segments, and the six segments of a road are successively a straight lane, an intersection, a straight lane, a straight lane, an intersection, and a straight lane from left to right.

730. Extend each segment of the road.

Specifically, each of the plurality of segments of the road is extended on condition of a lane (which may also be referred to as a non-violation lane) on which driving is performed in compliance with a traffic regulation, to obtain a first choice drivable area corresponding to each segment of the road, each of the plurality of segments of the road is extended on condition that driving is performed in compliance with a traffic regulation (which may also be referred to as a non-violation area), to obtain a compliance drivable area corresponding to each segment of the road, and each of the plurality of segments of the road is extended on condition that no collision occurs (which may also be referred to as a non-collision area), to obtain an emergency avoidance drivable area corresponding to each segment of the road.

For example, FIG. 9 shows an example of extending a segment of a road. As shown in FIG. 9, a black thick line is a planned route of the segment of the road, a lane on which the black thick line is located is extended to the left and the right, and different areas are generated based on different conditions. A “non-violation lane” is used as a condition to obtain a “first choice drivable area” through extension in FIG. 9. A “non-violation area” is used as a condition to obtain a “compliance drivable area” through extension in FIG. 9. A “non-collision area” is used as a condition to obtain an “emergency avoidance drivable area” through extension in FIG. 9.

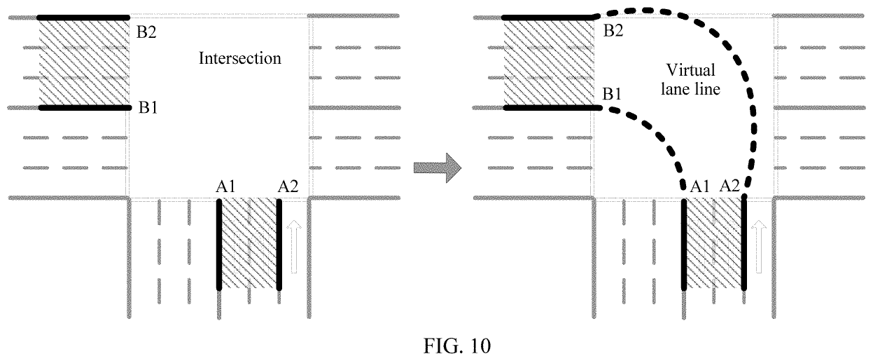

It should be specially noted that, if a current road segment falls within an intersection range, the first choice drivable area may be determined using a virtual lane line algorithm in this embodiment of this application. For example, as shown in FIG. 10, in this embodiment of this application, a smooth curve obtained through spline interpolation may be used as the “first choice drivable area”.

Specifically, as shown in FIG. 10, the TCU first obtains left and right boundary lines A1 and A2 of a drivable area that enters an intersection, and obtains left and right boundary lines B1 and B2 of a drivable area that leaves the intersection. Then curve fitting is performed on A1→B1 and A2→B2, to obtain a drivable area with virtual lane lines. It should be understood that, in this embodiment of this application, a virtual lane line may be obtained using a plurality of fitting algorithms, such as cubic spline interpolation, quadratic spline interpolation, or the least square method. This embodiment of this application is not limited thereto.

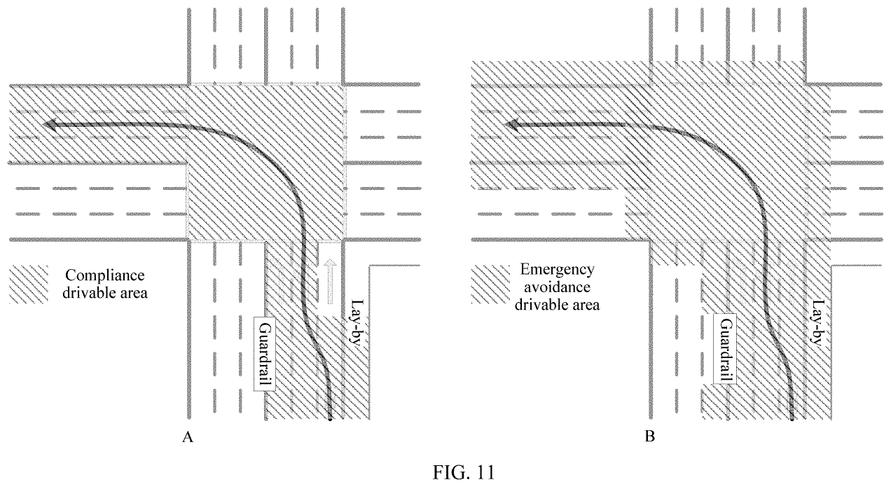

For a compliance drivable area and an emergency avoidance drivable area that are at intersections, as shown in FIG. 11, the following specification may be used. As shown in A in FIG. 11, the entire intersection is designated as the “compliance drivable area”. As shown in B in FIG. 11, the entire intersection and a lane that is obtained through extension outwards are the “emergency avoidance drivable area”.

It should be understood that FIG. 11 is merely an example. In this embodiment of this application, extension may further be performed according to another rule. This embodiment of this application is not limited thereto. For example, the “emergency avoidance drivable area” at the intersection may include the entire intersection and two or three lanes that are obtained through extension outwards.

740. Reckon a drivable area within a specific range in the manner in step 730.

When an entire drivable area is to be sent, the TCU may reckon a drivable area of a previous (next) segment of the road based on a vehicle driving direction, and another drivable area may be obtained through successive recursion, until the entire drivable area is obtained.

Optionally, in a scenario in which a drivable area is delivered by segments, only a drivable area within a segment range may be sent. For example, a drivable area that is 1000 meters in front of the current location and 200 meters behind the current location is sent.

230. The TCU sends road information to the OBU, where the road information includes indication information used for the drivable area.

Specifically, after determining the drivable area, the TCU may generate the indication information corresponding to the drivable area. Then the TCU sends the road information to the OBU, and the road information includes the indication information used to indicate the drivable area. In this way, the OBU may control the vehicle based on the road information. Specifically, the OBU may determine the drivable area based on the road information in order to control the vehicle based on the drivable area, for example, perform a function such as self driving, lane change, obstacle avoidance, collision prediction, or violation identification of the vehicle.

It should be understood that the indication information may indicate a drivable area on a segment of the road, or may indicate the drivable area on the entire planned route. This embodiment of this application is not limited thereto.

Optionally, the indication information includes at least one of the following two a left boundary line and a right boundary line that are used to indicate the drivable area, where the left boundary line indicates a left boundary on which the vehicle moves in the drivable area, and the right boundary line indicates a right boundary on which the vehicle moves in the drivable area, and lane information used to indicate the drivable area, where the lane information is used to indicate all lanes in the drivable area.

It should be understood that, in this embodiment of this application, the three areas may all be indicated using either of boundary lines or road information. The following provides detailed descriptions using an example in which the emergency avoidance drivable area and the compliance drivable area are indicated using boundary lines and the first choice drivable area is indicated using road information.

Correspondingly, in an embodiment, the indication information includes a first left boundary line and a first right boundary line that are used to indicate the emergency avoidance drivable area, where the first left boundary line indicates a left boundary on which a vehicle corresponding to the emergency avoidance drivable area moves, and the first right boundary line indicates a right boundary on which the vehicle corresponding to the emergency avoidance drivable area moves, a second left boundary line and a second right boundary line that are used to indicate the compliance drivable area, where the second left boundary line indicates a left boundary on which a vehicle corresponding to the compliance drivable area moves, the second right boundary line indicates a right boundary on which the vehicle corresponding to the compliance drivable area moves, and the second left boundary and the second right boundary are surrounded by the first left boundary and the first right boundary, and first lane information used to indicate the first choice drivable area, where the first lane information is used to indicate all the lanes when the vehicle complies with a traffic regulation.

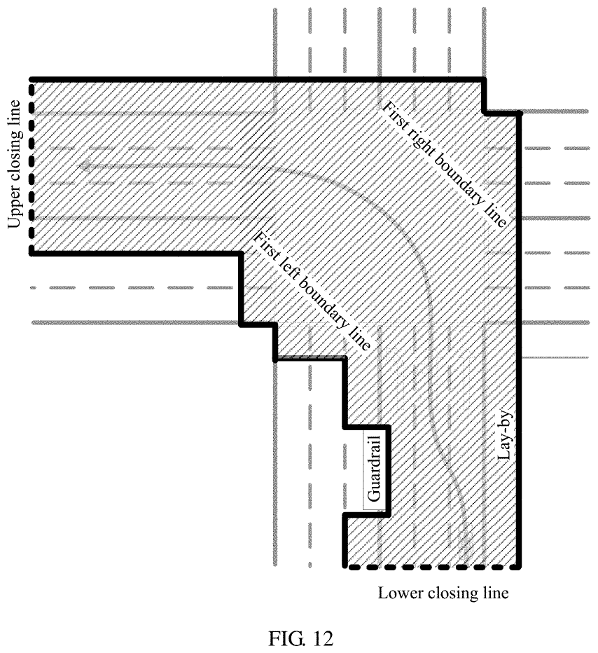

Specifically, the indication information of the drivable area delivered by the TCU to the OBU is usually a closed curve, and the OBU closes upper and lower ends of each of the left and right boundary lines, to obtain the closed curve. For example, FIG. 12 shows a first left boundary line and a first right boundary line that correspond to the emergency avoidance drivable area in this embodiment of this application.

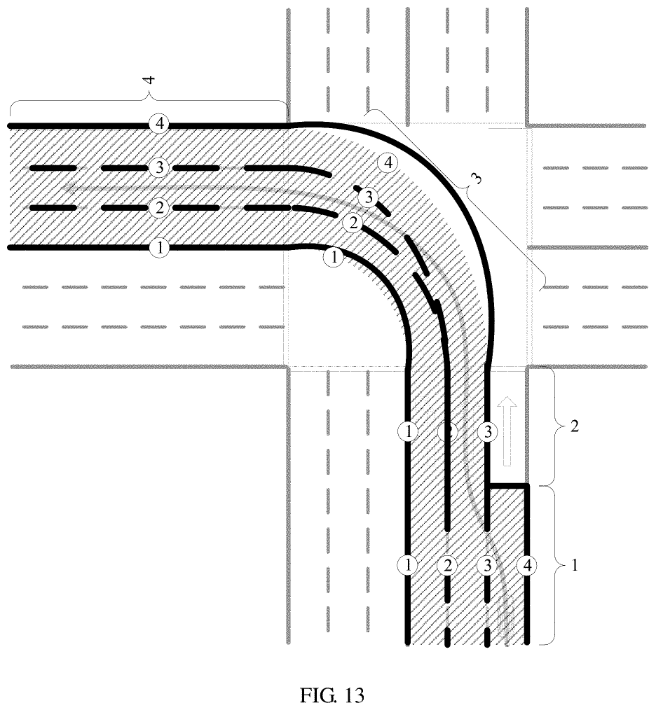

The “first choice drivable area” described in this specification is usually a “non-violation lane”. During implementation, the area may include attributes such as a lane line, a lane midline, a lane line type, and a direction. The OBU may perform V2X warning, trajectory planning, or the like based on the information. It should be understood that the lane information may have a plurality of forms in this embodiment of this application. The following separately describes, in three cases using the first choice drivable area as an example, first road information corresponding to the first choice drivable area in this embodiment of this application with reference to FIG. 13 to FIG. 15.

First Case

The first lane information includes lane lines of all the lanes on which the vehicle moves in compliance with a traffic regulation, and the lane lines include a virtual lane line at an intersection and actual lane lines on the lanes.

Optionally, the first lane information further includes directions of all the lanes on which the vehicle moves in compliance with a traffic regulation, and/or types of the lane lines.

For example, as shown in FIG. 13, black lines are a line set that needs to be used to express the first choice drivable area in this embodiment. Specifically, the area is segmented into a plurality of segments based on a calculation process of the drivable area in FIG. 7. For example, FIG. 13 is used as an example, and the area may be segmented into four segments a first segment, a second segment, a third segment, and a fourth segment along a driving direction. The third segment includes virtual lane lines.

Optionally, first road information corresponding to the first segment to the third segment of the drivable area may include content shown in Table 1 to Table 3, that is, a number, a type, a direction of a lane line, and a number of a lane line that is on a next segment and that is connected to the lane line. It should be understood that a “lane direction” in Table 1 to Table 3 is a direction of a lane whose corresponding lane line is a left line. Table 1 to Table 3 respectively show the first road information corresponding to the first segment to the third segment. Optionally, the first road information in this embodiment of this application may further include a color of a lane line, such as white or yellow. This embodiment of this application is not limited thereto.

Table 1 is used as an example. The first segment of a road corresponds to four lane lines whose numbers are 1 to 4, the lane lines 1 and 4 are solid lines (lane change is prohibited), and the lane lines 2 and 3 are dashed lines (lane change is allowed). Because the first segment is relatively far away from an intersection, the four lane lines have no lane direction. In addition, the lane lines 1 to 3 in the first segment of the road are respectively connected to lane lines 1 to 3 of the second segment of the road. Because the vehicle needs to turn left at the intersection, a left-turning road needs to be selected after the vehicle moves to the second segment that is of the road and that is close to the intersection. Because a road connected to the lane line 4 of the first segment of the road is a straight road, the lane line 4 of the first segment of the road is not connected to a lane line of the next segment of the road.

Similarly, content in Table 2 and Table 3 is similar to the content expressed in Table 1. A difference lies in that because the second segment is close to the intersection, the road on the second segment has a lane direction and the lane lines on the second segment are all solid lines (lane change is prohibited). Specifically, for the content in Table 2 and Table 3, refer to the descriptions in Table 1. Details are not described one by one herein again.

TABLE 1

| | | | Number of a |
|---|---|---|---|
| | Lane | Lane | next segment |
| Number | line type | direction | to be connected |
| 1 | Solid line | Null | 1 |
| 2 | Dashed line | Null | 2 |
| 3 | Dashed line | Null | 3 |
| 4 | Solid line | Null | Null |

TABLE 2

| | | | Number of a |
|---|---|---|---|
| | Lane | Lane | next segment |
| Number | line type | direction | to be connected |
| 1 | Solid line | Turn left | 1 |
| 2 | Solid line | Go straight | 2 and 3 |
| | | and turn left | |
| 3 | Solid line | Null | 4 |

TABLE 3

| | | | Number of a |
|---|---|---|---|
| | Lane | Lane | next segment |
| Number | line type | direction | to be connected |
| 1 | Solid line | Null | 1 |
| 2 | Dashed line | Null | 2 |
| 3 | Dashed line | Null | 3 |
| 4 | Solid line | Null | 4 |

Second Case

The first lane information includes lane midlines of all the lanes on which the vehicle moves in compliance with a traffic regulation.

Optionally, the first lane information further includes at least one of the following information a lane width, a lane direction, and a lane change attribute of a lane corresponding to a lane midline.

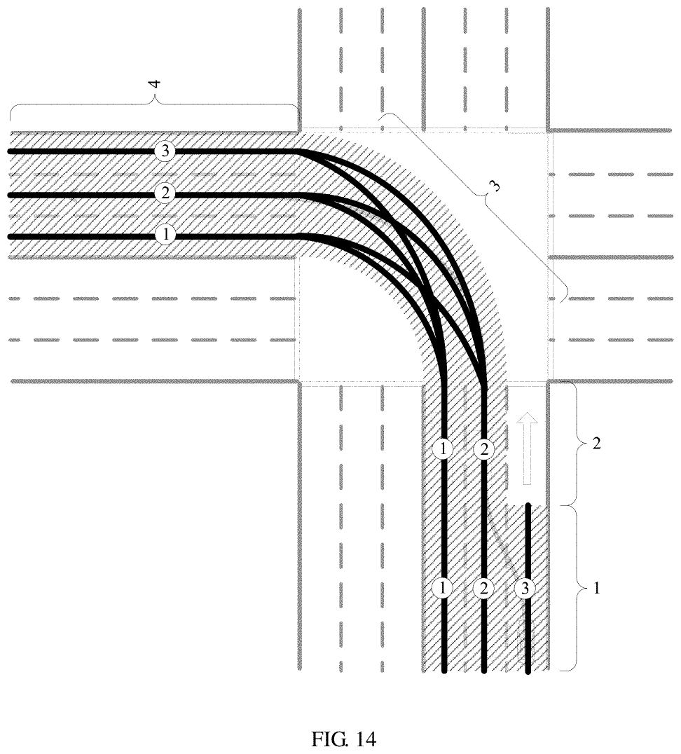

For example, as shown in FIG. 14, black lines are a line set that needs to be used to express the first choice drivable area in this embodiment. Specifically, the area is segmented into a plurality of segments based on a calculation process of the drivable area in FIG. 7. For example, FIG. 14 is used as an example, and the area may be segmented into four segments a first segment, a second segment, a third segment, and a fourth segment along a driving direction. The third segment includes virtual lane lines.

Optionally, first road information corresponding to the first segment to the third segment of the drivable area may include content shown in Table 4 to Table 6, that is, a number of a lane midline, a lane change attribute of a lane, a lane direction, a lane width, and a number of a lane midline that is on a next segment and that is connected to the lane midline. It should be understood that Table 4 to Table 6 respectively show the first road information corresponding to the first segment to the third segment.

Table 4 is used as an example. The first segment of a road corresponds to three lane midlines whose numbers are 1 to 3, and lane change attributes of lanes corresponding to the lane midlines 1 to 3 are that lane change may be performed to the right, that lane change may be performed to the left and the right, and that lane change may be performed to the left. Because the first segment is relatively far away from an intersection, the lanes corresponding to the three lane midlines have no lane direction. Lane widths corresponding to the three lane midlines are all 3 meters. In addition, the lane midlines 1 and 2 in the first segment of the road are respectively connected to the lane lines 1 and 2 of the second segment of the road. Because the vehicle needs to turn left at the intersection, a left-turning road needs to be selected after the vehicle moves to the second segment that is of the road and that is close to the intersection. Because a road connected to the lane midline 3 of the first segment of the road is a straight road, the lane midline 3 of the first segment of the road is not connected to a lane midline on the next segment of the road.

Similarly, content of Table 5 and Table 6 is similar to content expressed in Table 4. A difference lies in that because the second segment is close to the intersection, the road on the second segment has a lane direction, a lane change attribute of a lane corresponding to a lane midline on the second segment is prohibiting lane change, and the lane midline on the second segment may be connected to a plurality of lane midlines at the intersection of the third segment. A plurality of lane midlines on the third segment corresponding to Table 6 may be connected to a number of a same lane midline on the fourth segment. In addition, a direction of a lane on the third segment is null, and two lane midlines on the second segment may be randomly connected to three lane midlines on the fourth segment, to form lane midlines on the third segment. Therefore, six lane midlines may be included on the third segment. For example, as shown in Table 6, the six lane midlines include a lane midline 1-1 connected to a lane midline 1 on the second segment and to a lane midline 1 on the fourth segment, a lane midline 1-2 connected to the lane midline 1 on the second segment and to a lane midline 2 on the fourth segment, a lane midline 1-3 connected to the lane midline 1 on the second segment and to a lane midline 3 on the fourth segment, a lane midline 2-1 connected to a lane midline 2 on the second segment and to the lane midline 1 on the fourth segment, a lane midline 2-2 connected to the lane midline 2 on the second segment and to the lane midline 2 on the fourth segment, and a lane midline 2-3 connected to the lane midline 2 on the second segment and to the lane midline 3 on the fourth segment. Specifically, for the content in Table 5 and Table 6, refer to the descriptions in Table 4. Details are not described one by one herein again.

TABLE 4

| | | | | Number of a |
|---|---|---|---|---|
| | Lane change | Lane | Lane | next segment |
| Number | attribute | direction | width | to be connected |
| 1 | Lane change is | Null | 3 meters | 1 |
| | performed to | | | |
| | the right | | | |
| 2 | Lane change is | Null | 3 meters | 2 |
| | performed to | | | |
| | the left and | | | |
| | the right | | | |
| 3 | Lane change is | Null | 3 meters | Null |
| | performed to | | | |
| | the left | | | |

TABLE 5

| | | | | Number of a |
|---|---|---|---|---|
| | Lane change | Lane | Lane | next segment |
| Number | attribute | direction | width | to be connected |
| 1 | Prohibit | Turn left | 3 meters | 1-1, 1-2, 1-3 |
| 2 | Prohibit | Go straight and | 3 meters | 2-1, 2-2, 2-3 |
| | | turn left | | |

TABLE 6

| | | | | Number of a |
|---|---|---|---|---|
| | Lane change | Lane | Lane | next segment |
| Number | attribute | direction | width | to be connected |
| 1-1 | Lane change is | Null | 3 meters | 1 |
| | performed to | | | |
| | the right | | | |
| 1-2 | Lane change is | Null | 3 meters | 2 |
| | performed to | | | |
| | the left | | | |
| | and the right | | | |
| 1-3 | Lane change is | Null | 3 meters | 3 |
| | performed to | | | |
| | the left | | | |
| 2-1 | Lane change is | Null | 3 meters | 1 |
| | performed to | | | |
| | the right | | | |
| 2-2 | Lane change is | Null | 3 meters | 2 |
| | performed to | | | |
| | the left | | | |
| | and the right | | | |
| 2-3 | Lane change is | Null | 3 meters | 3 |
| | performed to | | | |
| | the left | | | |

Third Case

The first lane information includes a trajectory planning line on which the vehicle moves in compliance with a traffic regulation and a slicing line of the trajectory planning line, where the slicing line intersects a lane line and/or a lane midline that are/is passed when the vehicle moves in compliance with a traffic regulation.

Optionally, the first lane information further includes at least one of the following information a lane direction of a lane intersecting the slicing line, a type of the lane line, a width of the lane, and a lane change attribute.

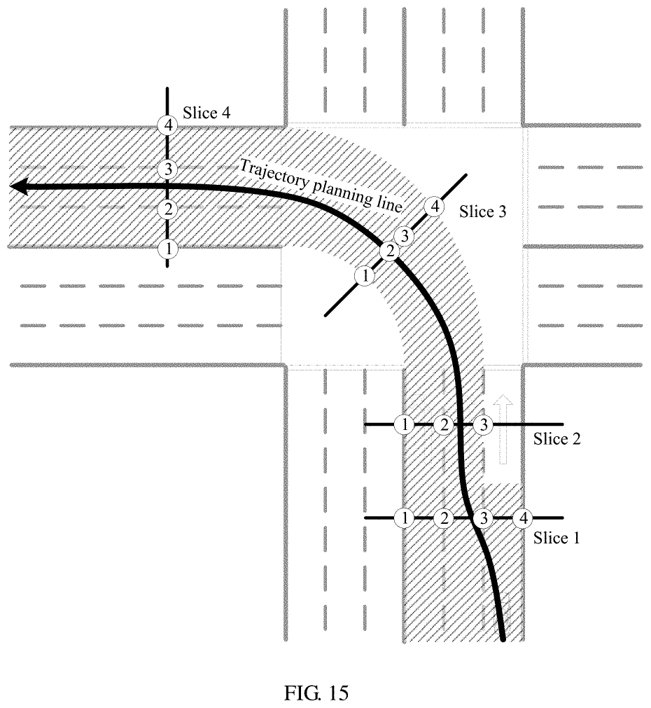

As shown in FIG. 15, a black line is a trajectory planning line, the trajectory planning line is constituted by consecutive points, and lane information is superimposed on each point, to deliver a drivable area.

Specifically, in this embodiment of this application, each trajectory planning point is indicated by a slicing line perpendicular to a road direction. Specifically, based on the calculation process of the drivable area in FIG. 7, the area is segmented into a plurality of segments. For example, FIG. 15 is used as an example. A slicing line 1 to a slicing line 4 may be respectively perpendicular slicing lines of points on the trajectory planning line on a first segment, a second segment, a third segment, and a fourth segment. The slicing line 3 is a virtual lane line.

It should be understood that FIG. 15 is merely an example. Trajectory points are relatively dense in actual application. For example, there is one point in every one meter. In other words, there is one slicing line in every one meter. This embodiment of this application is not limited thereto.

It should be understood that a slicing line may intersect a lane line or may intersect a lane midline. This embodiment of this application is not limited thereto. FIG. 15 shows a form in which a slicing line intersects a lane line.

Optionally, first road information corresponding to the first segment to the third segment of the drivable area may include content shown in Table 7 to Table 9, that is, a number of an intersecting point between a slicing line and a lane line, a type of a lane line of a lane intersecting the slicing line, a lane direction, and a number of a next intersecting point connected to the intersecting point number. It should be understood that a “lane direction” in Table 7 to Table 9 is a direction of a lane whose corresponding lane line is a left line. Table 7 to Table 9 respectively show the first road information corresponding to the first segment to the third segment.

Table 7 is used as an example, a first slicing line corresponds to four lane lines whose numbers are 1 to 4, the lane lines 1 and 4 are solid lines (lane change is prohibited), and the lane lines 2 and 3 are dashed lines (lane change is allowed). Because the first slicing line is relatively far away from an intersection, the four lane lines have no lane direction. In addition, the intersecting point lane lines 1 to 3 on the first slicing line are respectively connected to lane lines 1 to 3 on a second slicing line. Because a vehicle needs to turn left at the intersection, a left-turning road needs to be selected after the vehicle moves to the second slice on the second segment that is of the road and that is close to the intersection. Because a road connected to the lane line 4 on the first slicing line on the first segment of the road is a straight road, the lane line 4 on the first slicing line is not connected to a lane line on a next slicing line.

Similarly, content in Table 8 and Table 9 is similar to the content expressed in Table 7. A difference lies in that because the second slicing line on the second segment is close to the intersection, the road on the second slicing line has a lane direction and the lane lines on the second slicing line are all solid lines (lane change is prohibited). Specifically, for the content in Table 8 and Table 9, refer to the descriptions in Table 7. Details are not described one by one herein again.

TABLE 7

| | | | Number of a |
|---|---|---|---|
| | Lane | Lane | next segment |
| Number | line type | direction | to be connected |
| 1 | Solid line | Null | 1 |
| 2 | Dashed line | Null | 2 |
| 3 | Dashed line | Null | 3 |
| 4 | Solid line | Null | Null |

TABLE 8

| | | | Number of a |
|---|---|---|---|
| | Lane | Lane | next segment |
| Number | line type | direction | to be connected |
| 1 | Solid line | Turn left | 1 |
| 2 | Solid line | Go straight | 2 and 3 |
| | | and turn left | |
| 3 | Solid line | Null | 4 |

TABLE 9

| | | | Number of a |
|---|---|---|---|
| | Lane | Lane | next segment |
| Number | line type | direction | to be connected |
| 1 | Solid line | Null | 1 |
| 2 | Dashed line | Null | 2 |
| 3 | Dashed line | Null | 3 |
| 4 | Solid line | Null | 4 |

It should be understood that, in this embodiment of this application, to enable the OBU to replace a map with the drivable area, the TCU may further send additional information corresponding to the drivable area to the OBU. Correspondingly, in another embodiment, the road information further includes at least one of the following information traffic sign information, speed limiting information, traffic flow information, road grade information, a road material and a friction coefficient, traffic event information, and obstacle bitmap information.

It should be understood that the traffic event information may include information about road maintenance, a traffic accident, road construction, and the like, and the obstacle bitmap information may include bitmap information of a vehicle or an obstacle located in the drivable area.

Correspondingly, after obtaining the road information, the OBU may correspondingly control the vehicle. For example, in a self driving system, the OBU plans a trajectory of the vehicle in the drivable area, and may complete an action such as obstacle avoidance or lane change based on the drivable area.

In an assisted driving (ADAS/ITS/V2X) system, the OBU determines a spatio-temporal relationship between a vehicle and a peripheral vehicle in the drivable area, to implement a function such as collision prediction, lane change assistance, intersection guide, or violation identification.

It should be noted that the foregoing describes the method in a transport system scenario. Optionally, this embodiment of this application may be applied to another system, such as a robot system, an unmanned aerial vehicle system, or an automated warehouse system. In a robot system, an unmanned aerial vehicle system, an automated warehouse system, or the like, the TCU in this embodiment of this application may be replaced with a control center, the OBU may be replaced with a local apparatus, and the local apparatus may greatly simplify a route planning algorithm in the apparatus based on the drivable area. For a method applied to another system, refer to the foregoing descriptions of the transport system. Details are not described herein again.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains the road information such that calculation complexity of the OBU can be reduced, and vehicle control performance can be improved.

It should be noted that the examples in FIG. 1 to FIG. 15 are merely intended to help a person skilled in the art understand the embodiments of this application, rather than limiting the embodiments of this application to the specific values or specific scenarios that are shown using the examples. A person skilled in the art apparently can make various equivalent modifications or changes according to the examples shown in FIG. 1 to FIG. 15, and such modifications or changes also fall within the scope of the embodiments of this application.

It should be understood that sequence numbers of the foregoing processes do not mean execution sequences. The execution sequences of the processes should be determined according to functions and internal logic of the processes, and should not be construed as any limitation on the implementation processes of the embodiments of this application.

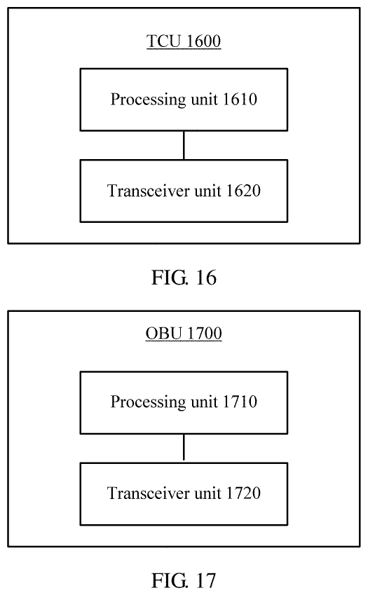

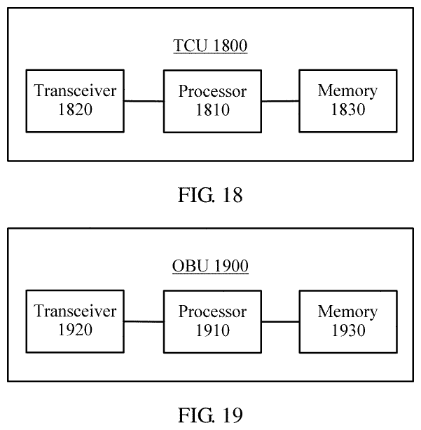

The foregoing describes the road information transmission method in the embodiment of this application. The following describes in detail a TCU in the embodiments of this application with reference to FIG. 16 and FIG. 18, and describes in detail an OBU in the embodiments of this application with reference to FIG. 17 and FIG. 19.

FIG. 16 is a schematic block diagram of a TCU 1600 according to an embodiment of this application. Specifically, as shown in FIG. 16, the TCU 1600 includes a processing unit 1610 and a transceiver unit 1620.

The processing unit is configured to obtain a planned route of a vehicle, and perform extension based on the planned route to generate a drivable area of the vehicle on the planned route, where the drivable area includes a safe driving area for the vehicle.

The transceiver unit is configured to send road information to an OBU, where the road information includes indication information of the drivable area.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

Optionally, in another embodiment, the drivable area includes at least one of a first choice drivable area, a compliance drivable area, and an emergency avoidance drivable area, the emergency avoidance drivable area includes the compliance drivable area, and the compliance drivable area includes the first choice drivable area, the first choice drivable area includes an area formed by all lanes on which the vehicle moves in compliance with a traffic regulation, the compliance drivable area includes all areas in which the vehicle moves in compliance with a traffic regulation, and the emergency avoidance drivable area includes an area in which no collision occurs when the vehicle moves.

Optionally, in another embodiment, the processing unit is specifically configured to segment the planned route into a plurality of segments of a road, extend each of the plurality of segments of the road on condition of a lane on which driving is performed in compliance with a traffic regulation, to obtain a first choice drivable area corresponding to each segment of the road, extend each of the plurality of segments of the road on condition that driving is performed in compliance with a traffic regulation, to obtain a compliance drivable area corresponding to each segment of the road, and extend each of the plurality of segments of the road on condition that no collision occurs, to obtain an emergency avoidance drivable area corresponding to each segment of the road.

Optionally, in another embodiment, the indication information includes at least one of the following two a left boundary line and a right boundary line that are used to indicate the drivable area, where the left boundary line indicates a left boundary on which the vehicle moves in the drivable area, and the right boundary line indicates a right boundary on which the vehicle moves in the drivable area, and lane information used to indicate the drivable area, where the lane information is used to indicate all lanes in the drivable area.

Optionally, in another embodiment, the indication information includes a first left boundary line and a first right boundary line that are used to indicate the emergency avoidance drivable area, where the first left boundary line indicates a left boundary on which a vehicle corresponding to the emergency avoidance drivable area moves, and the first right boundary line indicates a right boundary on which the vehicle corresponding to the emergency avoidance drivable area moves, a second left boundary line and a second right boundary line that are used to indicate the compliance drivable area, where the second left boundary line indicates a left boundary on which a vehicle corresponding to the compliance drivable area moves, the second right boundary line indicates a right boundary on which the vehicle corresponding to the compliance drivable area moves, and the second left boundary and the second right boundary are surrounded by the first left boundary and the first right boundary, and first lane information used to indicate the first choice drivable area, where the first lane information is used to indicate all the lanes when the vehicle complies with a traffic regulation.

Optionally, in another embodiment, the first lane information includes lane lines of all the lanes on which the vehicle moves in compliance with a traffic regulation, and the lane lines include a virtual lane line at an intersection and actual lane lines on the lanes.

Optionally, in another embodiment, the first lane information further includes directions of all the lanes on which the vehicle moves in compliance with a traffic regulation, and/or types of the lane lines.

Optionally, in another embodiment, the first lane information includes lane midlines of all the lanes on which the vehicle moves in compliance with a traffic regulation.

Optionally, in another embodiment, the first lane information further includes at least one of the following information a lane width, a lane direction, and a lane change attribute of a lane corresponding to the lane midline.

Optionally, in another embodiment, the first lane information includes a trajectory planning line on which the vehicle moves in compliance with a traffic regulation and a slicing line of the trajectory planning line, where the slicing line intersects a lane line and/or a lane midline that are/is passed when the vehicle moves in compliance with a traffic regulation.

Optionally, in another embodiment, the first lane information further includes at least one of the following information a lane direction of a lane intersecting the slicing line, a type of the lane line, a width of the lane, and a lane change attribute.

Optionally, in another embodiment, the road information further includes at least one of the following information traffic sign information, speed limiting information, traffic flow information, road grade information, a road material and a friction coefficient, traffic event information, and obstacle bitmap information.

Optionally, in another embodiment, the drivable area includes a safe driving area for the vehicle on the entire planned route, or the drivable area includes a safe driving area for the vehicle on a segment of a road on the planned route.

Optionally, in another embodiment, the processing unit is specifically configured to control the receiving unit to receive the planned route reported by the OBU, where the planned route is determined by the OBU, or the planned route is obtained by the OBU from a third-party device, or the processing unit is specifically configured to control the receiving unit to receive the planned route sent by a third-party device, or the receiving unit is further configured to receive the current location and the destination location that are reported by the OBU, or the processing unit is further configured to determine the destination location, and the receiving unit is further configured to receive the current location reported by the OBU, where the processing unit is specifically configured to perform route planning based on the current location and the destination location of the OBU, to obtain the planned route of the vehicle.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains the road information such that calculation complexity of the OBU can be reduced, and vehicle control performance can be improved.

It should be understood that the TCU 1600 shown in FIG. 16 can implement the processes of the TCU that are used in the method embodiments in FIG. 2 to FIG. 15. Operations and/or functions of the modules in the TCU are respectively intended to implement corresponding procedures in the method embodiments in FIG. 2 to FIG. 15. For details, refer to the descriptions in the foregoing method embodiments. To avoid repetition, detailed descriptions are properly omitted herein.

FIG. 17 is a schematic block diagram of an OBU 1700 according to an embodiment of this application. Specifically, as shown in FIG. 17, the OBU 1700 includes a processing unit 1710 and a transceiver unit 1720.

Specifically, the transceiver unit is configured to receive road information sent by a TCU, where the road information includes indication information of a drivable area, the drivable area includes a safe driving area for a vehicle, and the safe driving area is obtained by extending a vehicle planned route between a current location and a destination location of the OBU, and the processing unit is configured to control the vehicle based on the road information.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

Optionally, in another embodiment, the drivable area includes at least one of a first choice drivable area, a compliance drivable area, and an emergency avoidance drivable area, the emergency avoidance drivable area includes the compliance drivable area, and the compliance drivable area includes the first choice drivable area, the first choice drivable area includes an area formed by all lanes on which the vehicle moves in compliance with a traffic regulation, the compliance drivable area includes all areas in which the vehicle moves in compliance with a traffic regulation, and the emergency avoidance drivable area includes an area in which no collision occurs when the vehicle moves.

Optionally, in another embodiment, the indication information includes at least one of the following two a left boundary line and a right boundary line that are used to indicate the drivable area, where the left boundary line indicates a left boundary on which the vehicle moves in the drivable area, and the right boundary line indicates a right boundary on which the vehicle moves in the drivable area, and lane information used to indicate the drivable area, where the lane information is used to indicate all lanes in the drivable area.

Optionally, in another embodiment, the indication information includes a first left boundary line and a first right boundary line that are used to indicate the emergency avoidance drivable area, where the first left boundary line indicates a left boundary on which a vehicle corresponding to the emergency avoidance drivable area moves, and the first right boundary line indicates a right boundary on which the vehicle corresponding to the emergency avoidance drivable area moves, a second left boundary line and a second right boundary line that are used to indicate the compliance drivable area, where the second left boundary line indicates a left boundary on which a vehicle corresponding to the compliance drivable area moves, the second right boundary line indicates a right boundary on which the vehicle corresponding to the compliance drivable area moves, and the second left boundary and the second right boundary are surrounded by the first left boundary and the first right boundary, and first lane information used to indicate the first choice drivable area, where the first lane information is used to indicate all the lanes when the vehicle complies with a traffic regulation.

Optionally, in another embodiment, the first lane information includes lane lines of all the lanes on which the vehicle moves in compliance with a traffic regulation, and the lane lines include a virtual lane line at an intersection and actual lane lines on the lanes.

Optionally, in another embodiment, the first lane information further includes directions of all the lanes on which the vehicle moves in compliance with a traffic regulation, and/or types of the lane lines.

Optionally, in another embodiment, the first lane information includes lane midlines of all the lanes on which the vehicle moves in compliance with a traffic regulation.

Optionally, in another embodiment, the first lane information further includes at least one of the following information a lane width, a lane direction, and a lane change attribute of a lane corresponding to the lane midline.

Optionally, in another embodiment, the first lane information includes a trajectory planning line on which the vehicle moves in compliance with a traffic regulation and a slicing line of the trajectory planning line, where the slicing line intersects a lane line and/or a lane midline that are/is passed when the vehicle moves in compliance with a traffic regulation.

Optionally, in another embodiment, the first lane information further includes at least one of the following information a lane direction of a lane intersecting the slicing line, a type of the lane line, a width of the lane, and a lane change attribute.

Optionally, in another embodiment, the road information further includes at least one of the following information traffic sign information, speed limiting information, traffic flow information, road grade information, a road material and a friction coefficient, traffic event information, and obstacle bitmap information.

Optionally, in another embodiment, the drivable area includes a safe driving area for the vehicle on the entire planned route, or the drivable area includes a safe driving area for the vehicle on a segment of a road on the planned route.

Optionally, in another embodiment, the transceiver unit is further configured to send the current location and the destination location to the TCU, or the transceiver unit is further configured to send the current location to the TCU, or the processing unit is configured to determine the planned route, or the transceiver unit is configured to receive the planned route sent by a third-party device, and the transceiver unit is further configured to send the planned route to the TCU.

Therefore, in the road information transmission method provided in this embodiment of this application, a manner of sending a high-precision map is abandoned, and the TCU sends the drivable area to replace the high-precision map. The OBU may correspondingly control the vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains the road information such that calculation complexity of the OBU can be reduced, and vehicle control performance can be improved.

It should be understood that the OBU 1700 shown in FIG. 17 can implement the processes of the OBU that are used in the method embodiments in FIG. 2 to FIG. 15. Operations and/or functions of the modules in the OBU are respectively intended to implement corresponding procedures in the method embodiments in FIG. 2 to FIG. 15. For details, refer to the descriptions in the foregoing method embodiments. To avoid repetition, detailed descriptions are properly omitted herein.

FIG. 18 is a schematic block diagram of a TCU 1800 according to an embodiment of this application. Specifically, as shown in FIG. 18, the TCU 1800 includes a processor 1810 and a transceiver 1820. The processor 1810 is connected to the transceiver 1820. Optionally, the TCU 1800 further includes a memory 1830. The memory 1830 is connected to the processor 1810. The processor 1810, the memory 1830, and the transceiver 1820 communicate with each other using an internal connection path, to transfer a control signal and/or a data signal. The memory 1830 may be configured to store an instruction. Optionally, the memory 1830 may be further configured to store a map data source. The processor 1810 is configured to execute the instruction stored in the memory 1830 and control the transceiver 1820 to receive and send information or a signal. The controller 1810 executes the instruction in the memory 1830 such that processes of the TCU that are used in the method embodiments in FIG. 2 to FIG. 15 can be completed. To avoid repetition, details are not described herein again.

It should be understood that the TCU 1800 may correspond to the TCU 1600 in FIG. 16, a function of the processing unit 1610 in the TCU 1600 may be implemented by the processor 1810, and a function of the transceiver unit 1620 may be implemented by the transceiver 1820.

Therefore, in a road information transmission method provided in this embodiment of this application, a manner of sending a high-precision map is abandoned, and the TCU sends a drivable area to replace a high-precision map. An OBU may correspondingly control a vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains road information such that calculation complexity of the OBU can be reduced, and vehicle control performance can be improved.

FIG. 19 is a schematic block diagram of an OBU 1900 according to an embodiment of this application. Specifically, as shown in FIG. 19, the OBU 1900 includes a processor 1910 and a transceiver 1920. The processor 1910 is connected to the transceiver 1920. Optionally, the OBU 1900 further includes a memory 1930. The memory 1930 is connected to the processor 1910. The processor 1920, the memory 1930, and the transceiver 1920 communicate with each other using an internal connection path, to transfer a control signal and/or a data signal. The memory 1930 may be configured to store an instruction. The processor 1910 is configured to execute the instruction stored in the memory 1930 and control the transceiver 1920 to receive and send information or a signal. The controller 1910 executes the instruction in the memory 1930 such that processes of the OBU used in the method embodiments in FIG. 2 to FIG. 15 can be completed. To avoid repetition, details are not described herein again.

It should be understood that the OBU 1900 may correspond to the OBU 1700 in FIG. 17, a function of the processing unit 1710 in the OBU 1700 may be implemented by the processor 1910, and a function of the transceiver unit 1720 may be implemented by the transceiver 1920.

Therefore, in a road information transmission method provided in this embodiment of this application, a manner of sending a high-precision map is abandoned, and a TCU sends a drivable area to replace a high-precision map. The OBU may correspondingly control a vehicle after receiving the drivable area. Because the drivable area has a small amount of data, a transmission speed is high, the OBU quickly performs loading, and security is high. Therefore, there is no leakage of a high-precision map.

In addition, in this embodiment of this application, the drivable area provides more information than a route planning line, to meet a requirement for a function such as self driving, lane change, obstacle avoidance, collision prediction, or violation identification of the vehicle in the transport system.

It should be specially noted that, in a manner of sending a high-precision map by a server, not only an amount of transmitted data is large and it is difficult for the OBU to perform loading, but also the OBU needs to perform a calculation process such as route planning based on an obtained map, thereby increasing calculation burdens of the OBU. However, in this embodiment of this application, a TCU end performs route planning and route extension, and there is no need to perform a complex calculation process after the OBU obtains road information such that calculation complexity of the OBU can be reduced, and vehicle control performance can be improved.

It should be noted that the processor (such as the processor 1810 in FIG. 18 or the processor 1910 in FIG. 19) in the embodiments of this application may be an integrated circuit chip, and has a signal processing capability. During implementation, steps in the foregoing method embodiments can be implemented using a hardware integrated logic circuit in the processor, or using instructions in a form of software. The foregoing processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The processor may implement or perform the methods, the steps, and the logical block diagrams that are disclosed in the embodiments of this application. The general-purpose processor may be a microprocessor, or the processor may be any conventional processor or the like. Steps of the methods disclosed with reference to the embodiments of this application may be directly performed and accomplished using a hardware decoding processor, or may be performed and accomplished using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory (such as the memory 1830 in FIG. 18 or the memory 1930 in FIG. 19) in the embodiments of this application may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) and is used as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus random access memory (DR RAM). It should be noted that the memory of the systems and methods described in this specification includes but is not limited to these memories and any memory of another proper type.

It should be understood that the transceiver unit or the transceiver in the embodiments of this application may also be referred to as a communications unit, and communication between the TCU and the OBU may be performed using the communications unit. Specifically, using the communications unit, the OBU may send location information and receive road information sent by the TCU. The communications unit may receive and send the foregoing information using a radio frequency circuit.

It should be understood that, in this embodiment of this application, the OBU may further include an input unit and an output unit. The input unit is configured to implement interaction between a user and the OBU and/or input information into the OBU. For example, the input unit may receive digital or character information that is input by a user, to generate signal input related to user setting or function control. In a specific implementation of this application, the input unit may be a touch panel, may be another human-computer interaction interface, such as a physical input key or a microphone, or may be another external information capturing apparatus, for example, a camera. The touch panel, also referred to as a touchscreen or a touch control screen, may collect a touch of a user on the touch panel or an operation action near the touch panel, for example, an operation action performed by a user on the touch panel or at a location near the touch panel using any proper object or accessory such as a finger or a stylus, and driving of a corresponding connection apparatus based on a preset program. Optionally, the touch panel may include two parts a touch detection apparatus and a touch controller. The touch detection apparatus detects a touch operation of a user, converts the detected touch operation into an electrical signal, and transmits the electrical signal to the touch controller. The touch controller receives the electrical signal from the touch detection apparatus, converts the electrical signal into contact coordinates, and then sends the contact coordinates to the processing unit. The touch controller may further receive a command sent by the processing unit and execute the command. In addition, the touch panel may be implemented using a plurality of types, such as a resistive type, a capacitive type, an infrared type, and a surface acoustic wave type. In another implementation of this application, the physical input key used by the input unit may include but is not limited to one or more of a physical keyboard, a function key (such as a volume control key or an on/off key), a trackball, a mouse, and a joystick. The input unit in a form of a microphone may collect a voice that is input by a user or from an environment and convert the voice into a command that can be executed by the processing unit and that is in a form of an electrical signal. The output unit may include but is not limited to an image output unit, a sound output unit, and a haptic output unit. The image output unit is configured to output a text, an image, and/or a video. The image output unit may include a display panel, for example, a display panel configured in a form of a liquid crystal display (LCD), an organic light-emitting diode (OLED), a field emission display (FED), and the like. Alternatively, the image output unit may include a reflective display, such as an electrophoretic display or a display using interferometric modulation of light. The image output unit may include a single display or a plurality of displays of different sizes. In a specific implementation of this application, a touch panel used by the input unit can also serve as a display panel of the output unit. For example, after detecting a touch on the touch panel or a gesture operation near the touch panel, the touch panel sends the touch or the gesture operation to the processing unit to determine a type of a touch event. Then the processing unit provides corresponding visual output on the display panel according to the type of the touch event. It should be understood that the input unit and the output unit may be used as two independent parts to implement input and output functions of a mobile terminal. Optionally, in some embodiments, the touch panel and the display panel may be integrated into a whole to implement the input and output functions of the mobile terminal. For example, the image output unit may display various graphical user interfaces (GUI) as virtual control components, including but not limited to a window, a scroll bar, an icon, and a scrap book, to be operated by the user in a touch manner.

An embodiment of this application further provides a transport system. The system includes the foregoing TCU and the foregoing OBU. The OBU may be located in a vehicle.

An embodiment of this application further provides a computer readable medium. The computer readable medium stores a computer program. When the computer program is executed by a computer, the method in any one of the foregoing method embodiments is implemented.

An embodiment of this application further provides a computer program product. When the computer program product is executed by a computer, the method in any one of the foregoing method embodiments is implemented.

All or some of the foregoing embodiments may be implemented using software, hardware, firmware, or any combination thereof. When software is used to implement the embodiments, the embodiments may be implemented completely or partially in a form of a computer program product. The computer program product includes one or more computer instructions. When the computer instructions are loaded and executed on the computer, the procedure or functions according to the embodiments of this application are all or partially generated. The computer may be a general-purpose computer, a special-purpose computer, a computer network, or other programmable apparatuses. The computer instructions may be stored in a computer readable storage medium or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a high-density digital video disc (DVD), a semiconductor medium (for example, a solid state disk (SSD)), or the like.

It should be understood that the processing apparatus may be a chip, and the processor may be implemented using hardware or software. When the processor is implemented using hardware, the processor may be a logic circuit, an integrated circuit, or the like, when the processor is implemented using software, the processor may be a general-purpose processor, and is implemented by reading software code stored in a memory. The memory may be integrated into the processor, or may be located outside the processor, and exist independently.

It should be understood that “one embodiment” or “an embodiment” mentioned in the entire specification means that particular features, structures, or characteristics related to the embodiment are included in at least one embodiment of this application. Therefore, “in one embodiment” or “in an embodiment” appearing throughout this specification does not necessarily refer to a same embodiment. In addition, these particular features, structures, or characteristics may be combined in one or more embodiments in any appropriate manner. It should be understood that sequence numbers of the foregoing processes do not mean execution sequences in various embodiments of this application. The execution sequences of the processes should be determined according to functions and internal logic of the processes, and should not be construed as any limitation on the implementation processes of the embodiments of this application.

In addition, the terms “system” and “network” may be used interchangeably in this specification. The term “and/or” in this specification describes only an association relationship for describing associated objects and represents that three relationships may exist. For example, A and/or B may represent the following three cases Only A exists, both A and B exist, and only B exists. In addition, the character “/” in this specification generally indicates an “or” relationship between the associated objects.

It should be understood that in the embodiments of this application, “B corresponding to A” indicates that B is associated with A, and B may be determined according to A. However, it should further be understood that determining B according to A does not mean that B is determined only according to A, in other words, B may also be determined according to A and/or other information.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected depending on actual requirements to achieve the objectives of the solutions in the embodiments of this application.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

With descriptions of the foregoing implementations, a person skilled in the art may clearly understand that this application may be implemented by hardware, firmware or a combination thereof. When this application is implemented by software, the foregoing functions may be stored in a computer readable medium or transmitted as one or more instructions or code in the computer readable medium. The computer readable medium includes a computer storage medium and a communications medium, where the communications medium includes any medium that enables a computer program to be transmitted from one place to another. The storage medium may be any available medium accessible to a computer. The following provides an example but does not impose a limitation The computer readable medium may include a RAM, a ROM, an EEPROM, a CD-ROM, or another optical disc storage or a magnetic disk storage medium, or another magnetic storage device, or any other medium that can carry or store expected program code in a form of an instruction or a data structure and can be accessed by a computer. In addition, any connection may be appropriately defined as a computer readable medium. For example, if software is transmitted from a website, a server or another remote source using a coaxial cable, an optical fiber/cable, a twisted pair, a DSL or wireless technologies such as infrared, radio and microwave, the coaxial cable, optical fiber/cable, twisted pair, DSL or wireless technologies such as infrared, radio and microwave are included in fixation of a medium to which they belong. A disk and disc used in this application includes a compact disc (CD), a laser disc, an optical disc, a DVD, a floppy disk, and a BLU-RAY disc, where the disk generally copies data by a magnetic means, and the disc copies data optically by a laser means. The foregoing combination should also be included in the protection scope of the computer readable medium.

In summary, what is described above is merely example embodiments of the technical solutions of this application, but is not intended to limit the protection scope of this application. Any modification, equivalent replacement, or improvement made without departing from the spirit and principle of this application shall fall within the protection scope of this application.

1. An information transmission method, implemented by a traffic control unit (TCU), wherein the information transmission method comprises:
obtaining, a planned route of a vehicle;
performing extension of the planned route to generate a drivable area for the vehicle on the planned route, wherein the drivable area comprises a safe driving area for the vehicle; and
sending road information to an on-board unit (OBU), wherein the road information comprises indication information of the drivable area.

2. The information transmission method of claim 1, wherein the drivable area comprises at least one of a first choice drivable area, a compliance drivable area, or an emergency avoidance drivable area, wherein the emergency avoidance drivable area comprises the compliance drivable area, wherein the compliance drivable area comprises the first choice drivable area, wherein the first choice drivable area comprises an area formed by all lanes on which the vehicle moves in compliance with a traffic regulation, wherein the compliance drivable area comprises all areas in which the vehicle moves in compliance with the traffic regulation, and wherein the emergency avoidance drivable area comprises another area in which no collision occurs when the vehicle moves.

3. The information transmission method of claim 2, further comprising:
segmenting the planned route into a plurality of segments of a road;
extending each of the segments of the road on a first condition that a lane on which the vehicle is driving is performed in compliance with the traffic regulation to obtain the first choice drivable area corresponding to each of the segments of the road;
extending each of the segments of the road on a second condition that driving is performed in compliance with the traffic regulation to obtain the compliance drivable area corresponding to each of the segments of the road; and
extending each of the segments of the road on a third condition that no collision occurs to obtain the emergency avoidance drivable area corresponding to each of the segments of the road.

4. The information transmission method of claim 2, wherein the indication information comprises at least one of the following:
a left boundary line and a right boundary line that indicate the drivable area, wherein the left boundary line indicates a left boundary on which the vehicle moves in the drivable area, and wherein the right boundary line indicates a right boundary on which the vehicle moves in the drivable area; or
lane information indicating the drivable area, wherein the lane information indicates all lanes in the drivable area.

5. The information transmission method of claim 4, wherein the indication information comprises:
a first left boundary line and a first right boundary line that indicate the emergency avoidance drivable area, wherein the first left boundary line indicates a first left boundary on which a vehicle corresponding to the emergency avoidance drivable area moves, and wherein the first right boundary line indicates a first right boundary on which the vehicle corresponding to the emergency avoidance drivable area moves;
a second left boundary line and a second right boundary line that indicate the compliance drivable area, wherein the second left boundary line indicates a second left boundary on which a vehicle corresponding to the compliance drivable area moves, wherein the second right boundary line indicates a second right boundary on which the vehicle corresponding to the compliance drivable area moves, and wherein the second left boundary and the second right boundary are surrounded by the first left boundary and the first right boundary; and
first lane information indicating the first choice drivable area, wherein the first lane information indicates all the lanes when the vehicle complies with the traffic regulation.

6. The information transmission method of claim 5, wherein the first lane information comprises one of:
lane lines of all the lanes on which the vehicle moves in compliance with the traffic regulation, wherein the lane lines comprise a virtual lane line at an intersection and actual lane lines on the lanes,
lane midlines of all the lanes on which the vehicle moves in compliance with the traffic regulation; or
a trajectory planning line on which the vehicle moves in compliance with the traffic regulation and a slicing line of the trajectory planning line, wherein the slicing line intersects a lane line or a lane midline that is passed when the vehicle moves in compliance with the traffic regulation.

7. An information transmission method, implemented by an on-board unit (OBU), wherein the information transmission method comprises:
receiving road information from a traffic control unit (TCU), wherein the road information comprises indication information of a drivable area, wherein the drivable area comprises a safe driving area for a vehicle, and wherein the safe driving area is based on extending a planned route between a current location and a destination location of the OBU; and
controlling the vehicle based on the road information.

8. The information transmission method of claim 7, wherein the drivable area comprises at least one of a first choice drivable area, a compliance drivable area, or an emergency avoidance drivable area, wherein the emergency avoidance drivable area comprises the compliance drivable area, wherein the compliance drivable area comprises the first choice drivable area, wherein the first choice drivable area comprises an area formed by all lanes on which the vehicle moves in compliance with a traffic regulation, wherein the compliance drivable area comprises all areas in which the vehicle moves in compliance with the traffic regulation, and wherein the emergency avoidance drivable area comprises another area in which no collision occurs when the vehicle moves.

9. The information transmission method claim 8, wherein the indication information comprises at least one of the following:
a left boundary line and a right boundary line that indicate the drivable area, wherein the left boundary line indicates a left boundary on which the vehicle moves in the drivable area, and wherein the right boundary line indicates a right boundary on which the vehicle moves in the drivable area; or
lane information indicating the drivable area, wherein the lane information indicates all lanes in the drivable area.

10. The information transmission method of claim 9, wherein the indication information comprises:
a first left boundary line and a first right boundary line that indicate the emergency avoidance drivable area, wherein the first left boundary line indicates a first left boundary on which a vehicle corresponding to the emergency avoidance drivable area moves, and wherein the first right boundary line indicates a first right boundary on which the vehicle corresponding to the emergency avoidance drivable area moves;
a second left boundary line and a second right boundary line that the compliance drivable area, wherein the second left boundary line indicates a second left boundary on which a vehicle corresponding to the compliance drivable area moves, wherein the second right boundary line indicates a second right boundary on which the vehicle corresponding to the compliance drivable area moves, and wherein the second left boundary and the second right boundary are surrounded by the first left boundary and the first right boundary; and
first lane information indicating the first choice drivable area, wherein the first lane information indicates all the lanes when the vehicle complies with the traffic regulation.

11. A traffic control unit (TCU), comprising:
a processor configured to:
obtain a planned route of a vehicle; and
perform extension to generate a drivable area of the vehicle on the planned route of the planned route, wherein the drivable area comprises a safe driving area for the vehicle; and
a transceiver coupled to the processor and configured to send road information to an on-board unit (OBU), wherein the road information comprises indication information of the drivable area.

12. The TCU according of claim 11, wherein the drivable area comprises at least one of a first choice drivable area, a compliance drivable area, or an emergency avoidance drivable area, wherein the emergency avoidance drivable area comprises the compliance drivable area, wherein the compliance drivable area comprises the first choice drivable area, wherein the first choice drivable area comprises an area formed by all lanes on which the vehicle moves in compliance with a traffic regulation, wherein the compliance drivable area comprises all areas in which the vehicle moves in compliance with the traffic regulation, and wherein the emergency avoidance drivable area comprises another area in which no collision occurs when the vehicle moves.

13. The TCU of claim 12, wherein the processor is further configured to:
segment the planned route into a plurality of segments of a road;
extend each of the segments of the road on a first condition that a lane on which the vehicle is driving is performed in compliance with the traffic regulation to obtain the first choice drivable area corresponding to each of the segments of the road;
extend each of the segments of the road on a second condition that driving is performed in compliance with the traffic regulation to obtain the compliance drivable area corresponding to each of the segments of the road; and
extend each of the segments of the road on a third condition that no collision occurs to obtain the emergency avoidance drivable area corresponding to each of the segments of the road.

14. The TCU of claim 12, wherein the indication information comprises at least one of the following:
a left boundary line and a right boundary line that indicate the drivable area, wherein the left boundary line indicates a left boundary on which the vehicle moves in the drivable area, and wherein the right boundary line indicates a right boundary on which the vehicle moves in the drivable area; or
lane information indicating the drivable area, wherein the lane information indicates all lanes in the drivable area.

15. The TCU of claim 14, wherein the indication information comprises:
a first left boundary line and a first right boundary line that indicate the emergency avoidance drivable area, wherein the first left boundary line indicates a first left boundary on which a vehicle corresponding to the emergency avoidance drivable area moves, and wherein the first right boundary line indicates a first right boundary on which the vehicle corresponding to the emergency avoidance drivable area moves;
a second left boundary line and a second right boundary line that indicate the compliance drivable area, wherein the second left boundary line indicates a second left boundary on which a vehicle corresponding to the compliance drivable area moves, wherein the second right boundary line indicates a second right boundary on which the vehicle corresponding to the compliance drivable area moves, and wherein the second left boundary and the second right boundary are surrounded by the first left boundary and the first right boundary; and
first lane information indicating the first choice drivable area, wherein the first lane information indicates all the lanes when the vehicle complies with the traffic regulation.

16. The TCU of claim 15, wherein the first lane information comprises one of:
lane lines of all the lanes on which the vehicle moves in compliance with the traffic regulation, and wherein the lane lines comprise a virtual lane line at an intersection and actual lane lines on the lanes;
lane midlines of all the lanes on which the vehicle moves in compliance with the traffic regulation; or
a trajectory planning line on which the vehicle moves in compliance with the traffic regulation and a slicing line of the trajectory planning line, wherein the slicing line intersects a lane line or a lane midline that is passed when the vehicle moves in compliance with the traffic regulation.

17. An on-board unit (OBU), comprising:
a transceiver configured to receive road information from a traffic control unit (TCU), wherein the road information comprises indication information of a drivable area, wherein the drivable area comprises a safe driving area for a vehicle, and wherein the safe driving area is based on extending a vehicle planned route between a current location and a destination location of the OBU; and
a processor coupled to the transceiver and configured to control the vehicle based on the road information.

18. The OBU of claim 17, wherein the drivable area comprises at least one of a first choice drivable area, a compliance drivable area, or an emergency avoidance drivable area, wherein the emergency avoidance drivable area comprises the compliance drivable area, wherein the compliance drivable area comprises the first choice drivable area, wherein the first choice drivable area comprises an area formed by all lanes on which the vehicle moves in compliance with a traffic regulation, wherein the compliance drivable area comprises all areas in which the vehicle moves in compliance with the traffic regulation, and wherein the emergency avoidance drivable area comprises another area in which no collision occurs when the vehicle moves.

19. The OBU of claim 18, wherein the indication information comprises at least one of the following:
a left boundary line and a right boundary line that indicate the drivable area, wherein the left boundary line indicates a left boundary on which the vehicle moves in the drivable area, and wherein the right boundary line indicates a right boundary on which the vehicle moves in the drivable area; or
lane information indicating the drivable area, wherein the lane information all lanes in the drivable area.

20. The OBU of claim 19, wherein the indication information comprises:
a first left boundary line and a first right boundary line that indicate the emergency avoidance drivable area, wherein the first left boundary line indicates a first left boundary on which the vehicle corresponding to the emergency avoidance drivable area moves, and wherein the first right boundary line indicates a first right boundary on which the vehicle corresponding to the emergency avoidance drivable area moves;
a second left boundary line and a second right boundary line that indicate the compliance drivable area, wherein the second left boundary line indicates a second left boundary on which a vehicle corresponding to the compliance drivable area moves, wherein the second right boundary line indicates a second right boundary on which the vehicle corresponding to the compliance drivable area moves, and wherein the second left boundary and the second right boundary are surrounded by the first left boundary and the first right boundary; and
first lane information indicating the first choice drivable area, wherein the first lane information indicates all the lanes when the vehicle complies with the traffic regulation.
